(19) United States
(12) Patent Application Publication
(10) Pub. No.: US 2025/0383139 A1
(43) Pub. Date: Dec. 18, 2025

(54) REFRIGERATOR

(71) Applicant: Samsung Electronics Co., Ltd., Suwon-si (KR)

(72) Inventors: Elijah KIM, Suwon-si (KR); Eonjoong KIM, Suwon-si (KR); Chanyoung PARK, Suwon-si (KR); Hyunuk PARK, Suwon-si (KR); Duckjin SUNG, Suwon-si (KR); Geonhee LEE, Suwon-si (KR); Donghyun CHUN, Suwon-si (KR)

(21) Appl. No.: 19/196,439

(22) Filed: May 1, 2025

Related U.S. Application Data
(63) Continuation of application No. PCT/KR2025/005785, filed on Apr. 29, 2025.

(30) Foreign Application Priority Data
Jun. 17, 2024 (KR) 10-2024-0078174

(51) Int. Cl. F25D 23/02; E05F 15/614; E05F 15/73

(52) U.S. Cl. CPC F25D 23/028; E05F 15/614; E05F 15/73; E05Y 2900/31; F25D 2700/02

(57) ABSTRACT

A refrigerator is provided. The refrigerator includes a main body, a door rotatably connected to open or close the main body, a door driver configured to automatically rotate the door relative to the main body, a sensor disposed at one side of the main body or the door to face in a front direction, memory storing one or more computer programs, and one or more processors communicatively coupled to the door driver, the sensor, and the memory, wherein the one or more computer programs include computer-executable instructions that, when executed by the one or more processors individually or collectively, cause the refrigerator in a closed state of the door to determine whether a sensing data value obtained by the sensor is a first threshold value or less, control the door driver to open the door relative to the main body at a first designated angle based on determining that the sensing data value is the first threshold value or less, and control the door driver to open the door relative to the main body at a second designated angle larger than the first designated angle based on determining that the sensing data value exceeds the first threshold value.

### CROSS-REFERENCE TO RELATED APPLICATION(S)

This application is a continuation application, claiming priority under 35 U.S.C. § 365 (c), of an International application No. PCT/KR2025/005785, filed on Apr. 29, 2025, which is based on and claims the benefit of a Korean patent application number 10-2024-0078174, filed on Jun. 17, 2024, in the Korean Intellectual Property Office, the disclosures of which is incorporated by reference herein in its entirety.

### BACKGROUND

### 1. Field

The disclosure relates to a refrigerator.

### 2. Description of Related Art

A refrigerator is a device including a main body having a storage compartment and a cold air supply system for supplying cold air to the storage compartment to keep food fresh. The storage compartment includes a refrigerating compartment, which is maintained at about 0 to 5 degrees Celsius to refrigerate food, and a freezing compartment, which is maintained at about 0 to −30 degrees Celsius to freeze food. The storage compartment is designed to be open at the front for bringing in and taking out food.

The refrigerator repeats the cooling cycle in which the refrigerant is compressed, condensed, expanded, and evaporated by the compressor, condenser, expander, and evaporator. In this case, both the freezing compartment and refrigerating compartment may be cooled by a single evaporator installed on the freezing compartment side, or the freezing compartment and refrigerating compartment may each be equipped with an evaporator to cool independently.

The refrigerator includes a door that opens and closes the storage compartment. The door is provided to be rotatable from the main body to open and close the storage compartment.

The door may be provided so that the user may open and close it by gripping a handle provided on the door and rotating it from the main body. Alternatively, the refrigerator may include a door opening/closing structure configured to easily open or close the door.

The door may include a manual opening/closing door configured to be opened/closed by the user, and an automatic opening/closing door configured to be automatically opened/closed by a door opening/closing device according to the user's input. In the automatic opening/closing door, the user may move the door by directly exerting force at any time while the door is automatically opened or closed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a refrigerator.

Additional aspects will be set forth in part in the description which follows and, in part, will be apparent from the description, or may be learned by practice of the presented embodiments.

A refrigerator according to an embodiment of the disclosure may comprise a main body, a door rotatably connected to open or close the main body, a door driver configured to automatically rotate the door relative to the main body, a sensor disposed at one side of the main body or the door to face in a front direction, memory storing one or more computer programs, and one or more processors communicatively coupled to the door driver, the sensor, and the memory, wherein the one or more computer programs include computer-executable instructions that, when executed by the one or more processors individually or collectively, cause the refrigerator in a closed state of the door to: determine whether a sensing data value obtained by the sensor is a first threshold value or less, control the door driver to open the door relative to the main body at a first designated angle based on determining that the sensing data value is a first threshold value or less and, based on determining that the sensing data value exceeds the first threshold value, and control the door driver to open the door from the main body at a second designated angle larger than the first designated angle.

A refrigerator according to an embodiment of the disclosure may comprise a main body, a door rotatably connected to open or close the main body, a door driver configured to automatically rotate the door relative to the main body, a lever device disposed on the door to facilitate movement of the door, a guide provided to guide movement of the lever device while being contacted by the lever device when the door rotates to open or close the main body, a first sensor disposed on one side of the main body or the door to face in a forward direction to identify an external object, a second sensor disposed on one side of the door to face in the front direction to sense a distance based on identifying the external object by the first sensor, memory storing one or more computer programs, and one or more processors communicatively coupled to the door driver, the first sensor, the second sensor, and the memory, wherein the one or more computer programs include computer-executable instructions that, when executed by the one or more processors individually or collectively, cause the refrigerator in a closed state of the door to: obtain a distance value between the main body and the external object through the second sensor, and upon determining that the obtained distance value is a first threshold value or less, control the door driver to open the door at a first designated angle from the main body, wherein the guide includes a curve point which is a boundary point provided to apply a force in a direction in which the door opens or closes the main body among movement points of the lever device, wherein a curve angle may be defined as an angle of an imaginary line connecting the curve point and a rotation shaft of the door from the main body, and wherein the first designated angle has a value equal to or smaller than the curve angle.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a refrigerator according to an embodiment of the disclosure;

FIG. 2 is a view illustrating a refrigerator with a top table removed, as viewed from above according to an embodiment of the disclosure;

FIG. 3 is a block diagram illustrating a configuration of a refrigerator according to an embodiment of the disclosure;

FIG. 4 is a view illustrating a door driver disposed in a top table and a door of a refrigerator according to an embodiment of the disclosure;

FIG. 5 is a view illustrating a pusher, a link, and gears disposed in the door driver of FIG. 3 according to an embodiment of the disclosure;

FIG. 6 is a flowchart illustrating an open operation of a door from a main body according to an embodiment of the disclosure;

FIG. 7 is a view illustrating a position of a first sensor of a refrigerator according to an embodiment of the disclosure;

FIG. 8 is a view illustrating a position of a second sensor of a refrigerator according to an embodiment of the disclosure;

FIG. 9 is a view illustrating a first open state of a refrigerator and a distance between the refrigerator and an external object (e.g., the user) according to an embodiment of the disclosure;

FIG. 10 is a view illustrating a second open state of a refrigerator and a distance between the refrigerator and an external object (e.g., the user) according to an embodiment of the disclosure;

FIG. 11 is a view illustrating a first open state of a refrigerator as viewed from above the refrigerator according to an embodiment of the disclosure;

FIG. 12 is a see-through view illustrating a door driver in a first open state of the refrigerator of FIG. 10 according to an embodiment of the disclosure;

FIG. 13 is a view illustrating a second open state of a refrigerator as viewed from above the refrigerator according to an embodiment of the disclosure;

FIG. 14 is a see-through view illustrating a door driver in a second open state of the refrigerator of FIG. 12 according to an embodiment of the disclosure;

FIG. 15 is a see-through view illustrating an upper side of a refrigerator for comparison with a curve angle when a door is at a first designated angle from a main body according to an embodiment of the disclosure;

FIG. 16 is a view illustrating a guide and a lever device when a door is at a closed position in a refrigerator according to an embodiment of the disclosure;

FIG. 17 is a view illustrating a state in which when a door is opened in a refrigerator, a roller of a lever device moves along a first contact surface of a guide according to an embodiment of the disclosure;

FIG. 18 is a view illustrating a state in which a roller of a lever device contacts a curve point of a guide according to an embodiment of the disclosure;

FIG. 19 is a view illustrating a state in which when a door is opened in a refrigerator, a roller of a lever device moves along a second contact surface of a guide according to an embodiment of the disclosure;

FIG. 20 is a flowchart illustrating a door open operation with respect to a main body according to an embodiment of the disclosure;

FIG. 21 is a flowchart illustrating an open operation and a close operation of a door from a main body according to an embodiment of the disclosure;

FIG. 22 is a view illustrating an operation of a refrigerator from a first open state to a closed state according to an embodiment of the disclosure;

FIG. 23 is a view illustrating an operation of a refrigerator from a second open state to a closed state according to an embodiment of the disclosure;

FIG. 24 is a flowchart illustrating an open operation of a door from a main body according to an embodiment of the disclosure; and

FIG. 25 is a flowchart illustrating an open operation of a door from a main body according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiment described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular form “a,” “an,” and “the” include plural referents unless the context clearly dictates otherwise. Thus, for example, reference to “a component surface” includes reference to one or more of such surfaces.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

In the disclosure, the term “and/or” may denote a combination(s) of a plurality of related components as listed or any of the components.

In the disclosure, such terms as “1^{st}” and “2nd,” or “first” and “second” may be used to simply distinguish a corresponding component from another, and does not limit the components in other aspect (e.g., importance or order).

In the disclosure, the terms ‘front surface,’ ‘rear surface,’ ‘upper surface,’ ‘side surface,’ ‘left side,’ ‘right side,’ ‘upper portion,’ and ‘lower portion’ are defined with respect to the drawings, and the shape and position of each component are not limited by the terms.

It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to,” “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The refrigerator according to an embodiment may include a main body.

The “main body” may include an inner case, an outer case disposed outside the inner case, and an insulator provided between the inner case and the outer case.

The “inner case” may include at least one of a case, a plate, a panel, or a liner forming a storage compartment. The inner case may be formed as a single body or may be formed by assembling a plurality of plates. The “outer case” may form the outer appearance of the main body and may be coupled to an outer side of the inner case so that the insulator is disposed between the inner case and the outer case.

The “insulator” may insulate the inside of the storage compartment and the outside of the storage compartment so that the temperature inside the storage compartment is maintained at a set appropriate temperature without being affected by the environment outside the storage compartment. According to an embodiment, the insulator may include a foam insulator. The foam insulator may be formed by injecting and foaming a urethane foam formed by mixing polyurethane and a foaming agent between the inner case and the outer case.

According to an embodiment, the insulator may further include a vacuum insulator in addition to the foam insulator, or the insulator may be composed of only a vacuum insulator instead of the foam insulator. The vacuum insulation material may include a core material and an outer cover material that accommodates the core material and seals the inside at a pressure close to vacuum or vacuum. However, the insulator is not limited to the foam insulator or the vacuum insulator, and may include various materials that may be used for insulation.

The “storage compartment” may include a space limited by the inner case. The storage compartment may further include an inner case that limits a space corresponding to the storage compartment. Various items such as food, medicine, cosmetics, etc. may be stored in the storage compartment, and the storage compartment may be formed so that at least one side thereof is opened to take in and out the items.

The refrigerator may include one or more storage compartments. When two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a “refrigerating compartment,” a “freezing compartment,” or an “adjustable-temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a “vegetable compartment,” a “fresh compartment,” a “cooling compartment,” an “ice-making compartment,” and the like, in addition to the names “refrigerating compartment,” “freezing compartment,” and “adjustable-temperature compartment,” and the terms “refrigerating compartment,” “freezing compartment,” and “adjustable-temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front surface of the main body.

The “door” may be configured to seal the storage compartment when the door is closed. Like the main body, the door may include an insulator to insulate the storage compartment when the door is closed.

According to an embodiment, the door may include a door outer plate forming a front surface of the door, a door inner plate forming a rear surface of the door and facing the storage compartment, an upper cap, a lower cap, and a door insulator provided thereinside.

A gasket may be provided on the edge of the door inner plate to seal the storage compartment by being in close contact with the front surface of the main body when the door is closed. The door inner plate may include a dyke protruding rearward to mount a door basket capable of storing an object.

According to an embodiment, the door may include a door body and a front panel detachably coupled to a front side of the door body and forming a front surface of the door. The door body may include a door outer plate forming a front surface of the door body, a door inner plate forming a rear surface of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice making tray storing water, an ice maker separating ice from the ice making tray, and an ice bucket storing ice generated in the ice making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

Hereinafter, embodiments of the disclosure are described in detail with reference to the accompanying drawings.

Meanwhile, the terms “upper,” “lower,” “front,” and “rear” used in the following description are defined with respect to the drawings, and the shape and position of each component are not limited by these terms. For example, the terms “front” and “rear” below may mean the front and rear, respectively, of the refrigerator in the X direction with respect to the drawings. The terms “upper” and “lower” below may mean upper and lower, respectively, in the Z direction of the refrigerator with respect to the drawings. The terms “left” and “right” below may mean the left and right, respectively, in the Y direction of the refrigerator with respect to the drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

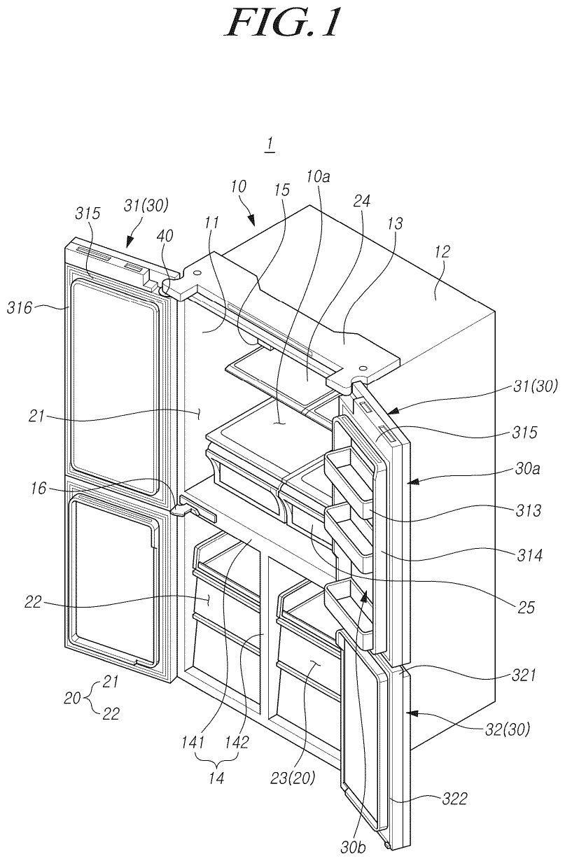

FIG. 1 is a perspective view illustrating a refrigerator according to an embodiment of the disclosure.

Referring to FIG. 1, a refrigerator 1 may include a main body 10, a storage compartment 20, a door 30, or a cold air supply device.

According to an embodiment, the storage compartment 20 may be partitioned into several spaces inside the main body 10. The door 30 may be disposed on the front surface of the main body 10 to open and close the storage compartment 20. The cold air supply device may be provided inside the main body 10 to supply cold air to, e.g., the storage compartment 20.

According to an embodiment, the main body 10 may include an inner housing 11 and/or an outer housing 12. The inner housing 11, e.g., may be provided to form an exterior of the storage compartment 20. The inner housing 11 may be integrally injection-molded with, e.g., a plastic material. The outer housing 12, e.g., may be provided to form at least a portion of the exterior of the refrigerator 1. The outer housing 12 may be formed of, e.g., a metal material having excellent durability and aesthetics. A receiving space may be formed between the inner housing 11 and the outer housing 12. A main body insulator (not shown) for insulating the storage compartment 20 may be provided in a portion of the receiving space.

According to an embodiment, the cold air supply device may generate cold air using a cooling circulation cycle for compressing, condensing, expanding, and evaporating the refrigerant.

According to an embodiment, the storage compartment 20 may be partitioned into a plurality of compartments by a partition wall 14. The storage compartment 20 may be formed by the inner housing 11 and the partition wall 14 of the main body 10. A plurality of shelves 24 or storage containers 25 may be provided inside the storage compartment 20 to store food or the like. The plurality of shelves 24 and the storage container 25 may be, e.g., removable.

According to an embodiment, the storage compartment 20 may be divided into a plurality of storage compartments 21, 22, and 23 by the partition wall 14. For example, as illustrated, the storage compartment 20 may include one first storage compartment 21 (e.g., an upper storage compartment) positioned at an upper portion, and a second storage compartments 22 (e.g., a lower storage compartment) and a third storage compartment 23 (e.g., a lower storage compartment) positioned at a lower portion.

According to an embodiment, the partition wall 14 may include a first partition wall 141 and a second partition wall 142. The partition wall 14 may have, e.g., a T-shaped cross section. The first partition wall 141 may be provided horizontally to divide, e.g., the first storage compartment 21 and the second and third storage compartments 22 and 23. The second partition wall 142 may be provided vertically to divide, e.g., the second storage compartment 22 and the third storage compartment 23. The second partition wall 142 may be formed to protrude downward from, e.g., the first partition wall 141. The illustrated second partition wall 142 is formed to protrude from the center of the first partition wall 141, but the disclosure is not limited thereto, and the sizes of the second storage compartment 22 and the third storage compartment 23 may vary depending on the position of the second partition wall 142.

The first storage compartment 21 of the illustrated storage compartment 20 may be used as a refrigerating chamber, and the second and third storage compartments 22 and 23 may be used as freezing chambers, but the disclosure is not limited thereto, and the position and number of each of the refrigerating chamber and the freezing chamber may vary depending on the user's needs.

According to an embodiment, the number, size, or shape of the storage compartment 20 may vary depending on the shape or position of the partition wall 14. The freezing chamber may be maintained at about minus 20 degrees Celsius, and the refrigerating chamber may be maintained at about 3 degrees Celsius. The storage compartment 20 may be insulated by, e.g., a partition wall 14.

According to an embodiment, the storage compartment 20 may be partitioned left and right by one vertical partition wall. Here, the vertical partition wall may be formed so that one end is in contact with the upper portion of the inner housing 11 and the other end is in contact with the lower portion of the inner housing 11. The size of the storage compartment 20 partitioned left and right may vary depending on the position of the vertical partition wall. For example, the storage compartment 20 having the vertical partition wall provided in the middle and partitioned left and right may be provided in mirror symmetry. According to an embodiment, there may be a plurality of vertical partition walls. When there are a plurality of vertical partition walls, three or more storage compartments 20 may be provided in the left-right direction.

According to an embodiment, the storage compartment 20 may be partitioned up and down only by one horizontal partition wall. In other words, the storage compartment 20 may be partitioned into two, e.g., the upper storage compartment and the lower storage compartment. Here, the horizontal partition wall may be formed so that one end thereof is in contact with the left portion of the inner housing 11 and the other end thereof is in contact with the right portion of the inner housing 11. The size of the storage compartment 20 partitioned up and down may vary depending on the position of the horizontal partition wall. According to an embodiment, there may be a plurality of horizontal partition walls. When there are a plurality of horizontal partition walls, three or more storage compartments 20 may be provided in the up-down direction. In addition to the above-described embodiment, a plurality of storage compartments 20 of various types may be configured according to the shape and number of partition walls 14.

According to an embodiment, the door 30 may include a first door 31 (e.g., an upper door) or a second door 32 (e.g., a lower door) as illustrated. The door 30 may be provided to open and close, e.g., the opening 10a of the main body 10. For example, a pair of first doors 31 (e.g., double door type) may be provided to open and close the first storage compartment 21. A pair of second doors 32 (e.g., double door type) may be provided to open or close, e.g., the second storage compartment 22 or the third storage compartment 23. Further, the number and shape of the doors 30 may vary depending on the number and shape of the storage compartment 20, and the door 30 may be configured in a sliding manner as well as a manner of rotating about the hinge 16.

According to an embodiment, a rotation bar 316 may be provided on one of the pair of first doors 31. The rotation bar 316 may be disposed, e.g., on a side opposite to a side of one of the pair of first doors 31 forming a rotation shaft. The rotation bar 316 may be provided such that, e.g., a rotation shaft is fixed to a side surface of one of the pair of first doors 31 to be rotatable about the rotation shaft. The rotation bar 316 may be provided to be positioned in the middle of the front surface of the main body 10 when one of the pair of first doors 31 is in a closed state. The rotation bar 316 may seal a gap between the pair of first doors 31 when the pair of first doors 31 are closed. The main body 10 may be provided with a rotation bar guide 15 for guiding the movement of the rotation bar 316 when one of the pair of first doors 31 is closed.

According to an embodiment, the door 30 (e.g., the first door 31 or the second door 32) may include a door panel 30a or a door body 30b. The door panel 30a and the door body 30b may be detachably coupled to each other.

According to an embodiment, for example, one side of the door body 30b may be fixed to the main body 10 by the hinge 16. The door body 30b may be provided to be rotatable about the main body 10. The door panel 30a may form, e.g., a portion of the front exterior of the refrigerator 1. The door panel 30a may play an important role for aesthetics, especially when the refrigerator 1 is disposed indoors. Accordingly, the user may decorate the front exterior of the refrigerator 1 as desired by replacing it with a door panel 30a having a different color or design. According to an embodiment, the door panel 30a and the door body 30b may be integrally formed with each other.

Hereinafter, for convenience of description, only one first door 31 and one second door 32 are described, and a description of the remaining first door 31 and the remaining second door 32 is omitted. However, the first door 31 and the second door 32, which are not described, may be substantially the same as the first door 31 and the second door 32, which are described below, except that they are provided to be symmetrical to each other. Further, the same configuration as that of the first door 31 may be applied to the second door 32, and a detailed description thereof may be omitted.

According to an embodiment, the first door 31 may include a first door handle (not shown), a first door shelf 313, a first shelf support 314, or a first gasket 315. The first door 31 may be rotatably coupled to the main body 10 to open and close at least a portion of the first storage compartment 21. The user may open and close the first door 31 using the first door handle. The first door handle may be recessed in the bottom surface of the first door 31 or may protrude from the front surface of the first door 31, but the disclosure is not limited thereto.

According to an embodiment, the first door shelf 313 may be provided to receive, e.g., food. First shelf supports 314 may be provided on both left and right sides of the first door shelf 313 to support the first door shelf 313. The first shelf support 314 may extend vertically from, e.g., the first door 31. In other words, the first shelf support 314 may be provided to protrude backward from the rear surface of the first door 31 and extend in the up-down direction. For example, the first shelf support 314 may be detachably provided on the first door 31 as a separate component, or may be integrally formed with the first door 31. The first shelf support 314 may be formed to protrude rearward from, e.g., the rear surface of the door body 30b.

According to an embodiment, the first gasket 315 may be provided to surround, e.g., a rear edge of the first door 31. Specifically, the first gasket 315 may be provided to surround an edge of the door body 30b. The first gasket 315 may be provided to seal a gap with the main body 10 in a state in which the first door 31 is closed.

According to an embodiment, the second door 32 may include a second door handle 321 or a second gasket 322. The second door 32 may be rotatably coupled to the main body 10 to open and close the second storage compartment 22 or the third storage compartment 23. The user may open and close the second door 32 using the second door handle 321. The second door handle 321 may be recessed in the upper surface of the second door 32 or may protrude from the front surface of the second door 32, but the disclosure is not limited thereto.

According to an embodiment, the second gasket 322 may be provided to surround, e.g., a rear edge of the second door 32. The second gasket 322 may be provided to seal a gap with the main body 10 in a state in which the second door 32 is closed.

Although not illustrated, the second door 32 may further include all or some of the same components as the first door shelf 313 and the first shelf support 314 of the first door 31.

According to an embodiment, the refrigerator 1 may include a top table 13 provided on an upper portion of the main body 10. The top table 13 may be coupled to an upper portion of the outer housing 12. For example, the top table 13 may be coupled to the upper surface of the outer housing 12. For example, the top table 13 may be fixed to the outer housing 12.

According to an embodiment, the top table 13 may cover the hinge bracket 40 of the upper door. In this sense, the top table 13 may be referred to as a hinge bracket cover.

According to an embodiment, the top table 13 may cover various electronic components. A receiving space in which various electronic components are received may be formed inside the top table 13. For example, the top table 13 may cover the door driver 400 to be described below, and the door driver 400 may be received inside the top table 13. Accordingly, the top table 13 may be referred to as a door driving cover. A more detailed description of the structure of the top table 13 is given below.

Although the refrigerator 1 according to an embodiment of the disclosure has been described as an example of the disclosure assuming that the refrigerator 1 is an indirect cooling-type refrigerator, the spirit of the disclosure is not limited thereto and may also be applied to a direct cooling-type refrigerator.

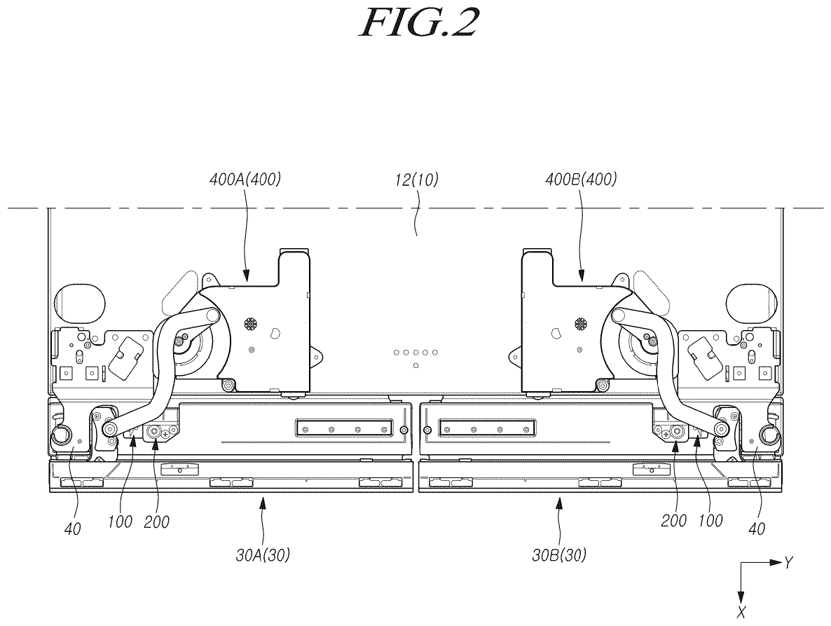

FIG. 2 is a view illustrating a refrigerator with a top table removed, as viewed from above according to an embodiment of the disclosure.

According to an embodiment, the refrigerator 1 may include a main body 10, a door 30, and/or a door driver 400.

According to an embodiment, the configuration of the main body 10, the door 30, and the door driver 400 of the refrigerator 1 of FIG. 2 may be identical in whole or part to the configuration of the main body 10, the door 30, and the door driver 400 of the refrigerator 1 of FIG. 1. The embodiment of FIG. 2 may be selectively combined with the embodiments of FIGS. 1 and 3 to 25.

According to an embodiment, the door driver 400 may be provided to automatically open the door 30. The door driver 400 may be provided to open the front surface of the main body 10 and/or the storage compartment 20 by automatically rotating the door 30 from the main body 10.

According to an embodiment, the door driver 400 may be provided to automatically close the door 30. The door driver 400 may be provided to automatically rotate the door 30 from the main body 10 so that the front surface and/or the storage compartment (e.g., the storage compartment 20 of FIG. 1) of the main body 10 is closed.

According to an embodiment, the door driver 400 may be mounted on the main body 10. The door driver 400 may open the door 30 by pressing the door 30 in an opening direction while being mounted on the main body 10. The door driver 400 may be provided to press the door 30 based on a condition for opening the door 30.

According to an embodiment, the door driver 400 may be provided to automatically open the first storage compartment 21. For example, the refrigerator 1 may include a first door driver 400A provided to open a 1-1th door 30A and a second door driver 400B provided to open a 1-2th door 30B.

According to an embodiment, the first door driver 400A may be provided to open the 1-1th door 30A. The first door driver 400A may be provided to automatically open the 1-1th door 30A based on a condition for opening the 1-1th door 30A. The first door driver 400A may be provided to open a portion of the first storage compartment 21 by rotating the 1-1th door 30A from the main body 10.

According to an embodiment, the second door driver 400B may be provided to open the 1-2th door 30B. The second door driver 400B may be provided to automatically open the 1-2th door 30B based on a condition for opening the 1-2th door 30B. The second door driver 400B may be provided to open another portion of the first storage compartment 21 by rotating the 1-2th door 30B from the main body 10.

According to an embodiment, the first door driver 400A and the second door driver 400B may be provided to open the first storage compartment 21 independently of each other.

According to an embodiment, the door driver 400 may be mounted on an upper portion of the main body 10. For example, the door driver 400 may be received inside the top table (e.g., the top table 13 of FIG. 1). An upper portion of the door driver 400 may be covered by the top table 13. The door driver 400 may be disposed on the upper surface of the outer housing 12. Referring to FIG. 2, the first door driver 400A may be disposed on the left side of the center of the upper portion of the main body 10, and the second door driver 400B may be disposed on the right side of the center of the upper portion of the main body 10. For example, the first door driver 400A and the second door driver 400B may be arranged in parallel in the horizontal direction Y.

According to an embodiment, the door driver 400 may be mounted on an upper portion of the main body 10 to press the upper portion of the door 30. For example, the first door driver 400A may be provided to press the upper portion of the 1-1th door 30A. Further, the second door driver 400B may be provided to press the upper portion of the 1-2th door 30B.

The position and structure of the door driver 400 are not limited to the above disclosure, but may be mounted at various positions of the main body 10, and may be provided to open the first storage compartment 21 by pressing various portions other than the upper portion of the 1-1th door 30A or the 1-2th door 30B.

For example, the door driver 400 may be mounted on a horizontal partition (e.g., the first partition 141 of FIG. 1) to press the lower portion of the 1-1th door 30A or the 1-2th door 30B.

For example, the door driver 400 may be provided to open the second storage compartment (e.g., the second storage compartment 22 of FIG. 1). The door driver 400 may be provided to press the door based on a condition for opening the second storage compartment 22. The door driver 400 may be mounted on a lower portion of the main body 10, or may be mounted on a horizontal partition (e.g., the first partition 141 of FIG. 1).

For example, the door driver 400 may be provided to open the third storage compartment (e.g., the third storage compartment 23 of FIG. 1). The door driver 400 may be provided to press the door based on a condition for opening the third storage compartment 23. The door driver 400 may be mounted on a lower portion of the main body 10, or may be mounted on a horizontal partition (e.g., the first partition 141 of FIG. 1).

The following description assumes that, for convenience of description, the door driver 400 is mounted on the upper portion of the main body 10 to open the first storage compartment 21 by pressing the 1-1th door 30A or the 1-2th door 30B.

Hereinafter, the first door driver 400A of the first door driver 400A and the second door driver 400B is described as an example for convenience of description, and the first door driver 400A may be referred to as a ‘door driver 400’ for convenience. The characteristics of the door driver 400 described below may be applied to correspond to the second door driver 400B.

According to an embodiment, the refrigerator 1 may include a guide 200. The guide 200 may be provided to guide rotation of the door 30 when the door 30 is opened or closed. According to an embodiment, the guide 200 may be provided to lead the door 30 to rotate in a specific direction according to the position of the door 30. According to an embodiment, the guide 200 may be provided to assist the door 30 in opening or closing according to the position of the door 30.

According to an embodiment, when the door 30 is opened or closed, the guide 200 may be provided to apply a force to the door 30 in the direction in which the door 30 is opened or closed according to the position of the door 30 (or the position of the component (e.g., the lever device 100) connected to the door 30). Hereinafter, the position of the door 30 may include the position of a component (e.g., the lever device 100) connected to the door 30 to move together.

According to an embodiment, according to the relative position of the door 30 with respect to the guide 200, the door 30 may receive a force in the direction of being opened or in the direction of being closed by the guide 200. For example, when the door 30 is opened, if the door 30 is positioned at a specific position with respect to the guide 200, the guide 200 may guide the rotation of the door 30 to rotate in the direction in which the door 30 is opened. For example, when the door 30 is closed, if the door 30 is positioned at a specific position with respect to the guide 200, the guide 200 may guide the rotation of the door 30 to rotate in the direction in which the door 30 is closed.

According to an embodiment, if the direction of rotation when the door 30 is opened is a first direction and the direction of rotation when the door 30 is closed is a second direction, according to the position of the door 30 with respect to the guide 200 when the door 30 rotates in the first direction or in the second direction, the guide 200 may guide the door 30 to rotate in the first direction by transferring a force for rotation in the first direction to the door 30 or guide the door 30 to rotate in the second direction by transferring a force for rotation in the second direction to the door 30.

According to an embodiment, the guide 200 may be fixed to the main body 10. For example, the guide 200 may be coupled to the hinge bracket 40. The guide 200 may be coupled to the hinge bracket 40 of the upper door. For example, the guide 200 may be integrally formed with the hinge bracket 40 of the upper door.

According to an embodiment, the refrigerator 1 may include a lever device 100. The lever device 100 may be mounted on the door 30. For example, the lever device 100 may be mounted on an upper portion of the door 30.

According to an embodiment, the lever device 100 may include a lever provided to contact the guide 200 when the door 30 is opened or closed. The lever device 100 may receive a force from the guide 200 when the lever 130 contacts the guide 200. When the lever 130 contacts the guide 200, the force applied from the guide 200 may vary depending on the relative position of the lever 130 with respect to the guide 200. Here, “the force applied by the lever device 100 from the guide 200 varies” may be understood as the magnitude or direction of the force applied to the lever device 100 from the guide 200 may be varied depending on the relative position of the lever 130 contacting the guide 200.

According to an embodiment, the lever device 100 may transfer a force to the door 30 in a direction in which the door 30 is opened or in a direction in which the door 30 is closed according to the relative position of the lever 130 with respect to the guide 200 when the lever 130 contacts the guide 200. For example, when the door 30 is opened, the lever device 100 may transfer a force in the direction in which the door 30 is opened to the door 30 according to the position of the lever connected to the door 30. For example, when the door 30 is closed, the lever device 100 may transfer a force in the direction in which the door 30 is closed to the door 30 according to the position of the lever connected to the door 30.

According to an embodiment, if the direction of rotation when the door 30 is opened is the first direction and the direction of rotation when the door 30 is closed is the second direction, the lever device 100 may transfer a force of rotation in the first direction to the door 30 or a force of rotation in the second direction to the door 30 according to the position of the lever connected to the door 30 when the door 30 rotates in the first direction or the second direction.

The following description assumes that, for convenience of description, the guide 200 is coupled to the hinge bracket 40 of the upper door, and the lever device 100 is mounted on the upper portion of the 1-1th door 30A or the upper portion of the 1-2th door 30B to guide the rotation of the 1-1th door 30A or the 1-2th door 30B. However, various design changes are possible, like the guide is coupled to the lower door hinge bracket, and the lever device 100 is mounted on the upper portion of the lower door to guide the rotation of the lower door.

According to an embodiment, the door 30 may be rotatably provided between an open position to open the storage compartment 20 to the maximum and a closed position to close the storage compartment 20.

According to an embodiment, the storage compartment 20 may be opened when the door 30 rotates from the closed position to the open position, and the storage compartment 20 may be closed when the door 30 rotates from the open position to the closed position. The open position and the closed position of the door 30 may be defined as relative positions with respect to the main body 10 and the storage compartment 20.

According to an embodiment, the door 30 may be opened while rotating in the first direction, and may be closed while rotating in the second direction opposite to the first direction. In other words, the door 30 may be provided to rotate in the first direction from the closed position toward the open position, and may be closed while rotating in the second direction from the open position toward the closed position.

According to an embodiment, the opening angle of the door 30 may be defined as an angle at which the door 30 rotates from the closed position. For example, the opening angle of the door 30 may be defined as an angle at which the door 30 rotates in the first direction from the closed position. As the opening angle of the door 30 increases, the degree to which the door 30 opens the storage compartment 20 may increase. The opening position of the door 30 may be defined as the position of the door 30 when the opening angle of the door 30 is maximum.

According to an embodiment, the door 30 may be provided to be rotatable about the rotation shaft extending in one direction. For example, as shown, the door 30 may be rotatably provided around the rotation shaft extending in the vertical direction Z.

According to an embodiment, the rotation shaft of the door 30 may be determined differently according to the connection relationship between the door 30 and the main body 10. The rotation shaft of the door 30 may pass through the door 30 and the hinge bracket 40. Accordingly, the door 30 may be provided to be rotatable with respect to the hinge bracket 40 about the rotation shaft.

According to an embodiment, when the hinge bracket 40 is fixed to the main body 10, and the portion where the door 30 and the hinge bracket 40 are connected to each other is fixed to the main body 10, the rotation shaft of the door 30 may be defined as a virtual straight line fixed to the main body 10. For example, the door 30 may be provided to be rotatable between the open position and the closed position around the rotation shaft fixed to the main body 10.

However, when the door 30 opens or closes the storage compartment 20, if the hinge bracket 40 moves with respect to the main body 10 or the portion where the door 30 and the hinge bracket 40 are connected to each other moves with respect to the main body 10 (e.g., an articulated hinge type including multiple links in which the hinge brackets are rotatably connected to each other), the rotation shaft of the door 30 may not be fixed to the main body 10. Even in this case, the opening angle of the door 30 may be defined as the angle at which the door 30 is rotated in the first direction from the closed position, and the opening angle of the door 30 increases as the door 30 rotates from the closed position to the open position.

The above-described door driver 400 may be provided to rotate the door 30 from the closed position toward the open position. The door driver 400 may press the door 30 to rotate the door 30 toward the open position.

The above-described guide 200 may be provided to guide the rotation of the door 30 when the door 30 is opened or closed. The guide 200 may apply force to the door 30 while the door 30 is opened or closed. When the door 30 is opened, the magnitude or direction of the force applied to the door 30 by the guide 200 may vary depending on the opening angle of the door 30. Further, when the door 30 is closed, the magnitude or direction of the force applied to the door 30 by the guide 200 may vary depending on the opening angle of the door 30.

The lever device 100 described above may be mounted on the door 30 to move together with the door 30 when the door 30 is opened or closed. When the door 30 is opened or closed, the lever device 100 may contact the guide 200 to transfer a force to the door 30. The relative position of the lever device 100 with respect to the guide 200 may vary depending on the opening angle of the door 30, and the point at which the lever 130 of the lever device 100 contacts the guide 200 may vary depending on the opening angle of the door 30. The magnitude and direction of the force applied to the door 30 may vary depending on which point on the guide 200 the lever 130 of the lever device 100 contacts.

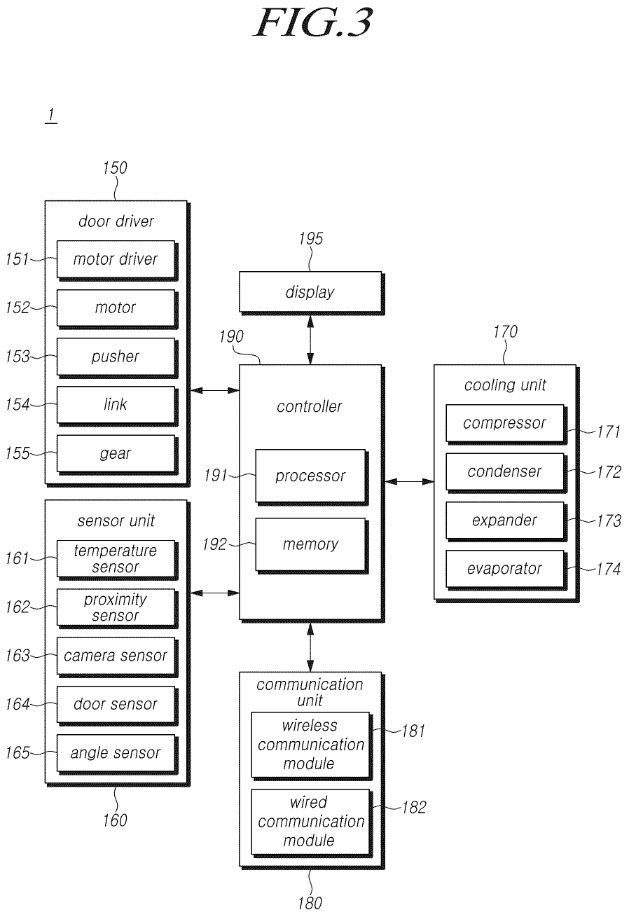

FIG. 3 is a block diagram illustrating a configuration of a refrigerator according to an embodiment of the disclosure.

According to an embodiment, the refrigerator 1 may include a door driver 150, a sensor unit 160, a cooling unit 170, a communication unit 180, a controller 190, and a display 195.

According to an embodiment, the door driver 150 may control opening or closing of at least one door. The door driver 150 may include at least one of a motor driver 151, a motor 152, a pusher 153, a link 154, and a gear 155. For example, the door driver 150 may precisely control the movement of at least one door 30 according to whether at least one door 30 is opened or the degree of opening.

According to an embodiment, the motor driver 151 may control the motor. For example, the motor driver 151 may activate or deactivate the motor 152. For example, the motor driver 151 may control the operation state of the motor 152 by supplying or cutting off power to the motor 152.

According to an embodiment, the motor 152 may open at least one door by rotating. For example, the motor 152 may be activated based on the control of the motor driver, thereby opening at least one door. For example, the motor 152 may be deactivated based on the control of the motor driver, thereby closing at least one door.

According to an embodiment, the pusher 153 may push the door 30 to open the door 30 from the main body 10 or the storage compartment 20. For example, the pusher 153 may receive the power transferred from the motor 152 through the gear 155 to slide in the front direction from the main body 10 or the storage compartment 20.

According to an embodiment, the link 154 may push the door 30 to open the door 30 from the main body 10 or the storage compartment 20. One side of the link 154 may be connected to the main body 10, and the other side may be rotatably connected to the door 30. For example, the link 154 may receive the power transferred from the motor 152 through the gear 155 to open the door 30 while sliding in the front direction from the main body 10 or the storage compartment 20.

According to an embodiment, the gear 155 may transfer the power transferred from the motor 152 to the pusher 153 and/or the link 154. For example, the gear 155 is a plurality of power transfer members and may include a pinion gear for transferring power to the pusher 153. For example, the gear 155 is a plurality of power transfer members and may include a link gear for transferring power to the link 154.

According to an embodiment, the sensor unit 160 may include a temperature sensor 161, a proximity sensor 162, a camera sensor 163, a door opening/closing sensor 164 (e.g., a distance detection sensor), and an angle sensor 165.

According to an embodiment, the temperature sensor 161 may sense the temperature around the refrigerator 1 or inside the refrigerator 1. For example, the temperature sensor 161 may include a plurality of temperature sensors for sensing the temperature inside the storage compartment 20. For example, the temperature sensor 161 may include a plurality of temperature sensors for sensing the external temperature around the refrigerator 1.

For example, the plurality of temperature sensors may be installed in the plurality of storage compartments 20, respectively, to sense the temperature of each of the plurality of storage compartments 20 and output an electrical signal corresponding to the sensed temperature to the controller 190. Each of the plurality of temperature sensors may include a thermistor whose electrical resistance changes according to temperature.

According to an embodiment, the proximity sensor 162 may be a sensor that detects whether a distance to a person or an object is close within a predetermined distance by detecting a change in distance from a person or an object. For example, the proximity sensor 162 may identify the user's approach and detect the distance between the user and the refrigerator 1.

For example, the proximity sensor 162 may include at least one of an infrared sensor, an ultrasonic sensor, a capacitive sensor, and an inductive sensor.

According to an embodiment, the camera sensor 163 may be a sensor that generates a digital image by converting light collected in a sensing area into an electrical signal. For example, the camera sensor 163 may photograph objects around the refrigerator 1 or inside the refrigerator 1 and generate a digital image.

For example, the camera sensor 163 may include at least one of a complementary metal-oxide-semiconductor (CMOS) sensor, a charge-coupled device (CCD) sensor, an IR camera, and an RGB camera.

According to an embodiment, the distance detection sensor 164 may detect the distance between the door 30 and the external object (e.g., the user) and transfer a value determined according to a designated distance to the processor 191.

According to an embodiment, the angle sensor 165 may detect the angle between the refrigerator main body 10 and the door 30 and transfer a value determined according to a designated angle value to the processor 191. The angle sensor 165 may detect the position of the door 30 by various methods. For example, the angle sensor 165 may be provided to detect the magnetic field of a magnet mounted adjacent to the door driver 150 (e.g., the gear 155). The angle sensor 165 may detect a change in magnetic field by the magnet according to the movement of the door 30. For example, the angle sensor 165 may include a hall sensor detecting the magnetic field. However, the type of the angle sensor 165 is not limited thereto, and may include various types of sensors capable of detecting the angle of the door 30 from the main body 10. For example, the position detection sensor coupled to gear 450 may include various types of sensors such as a reed switch or an optical sensor.

According to an embodiment, the cooling unit 170 may supply cooled air to the storage compartment. Specifically, the cooling unit 170 may maintain the temperature of the storage compartment within a range designated by the user using the circulation of the refrigerant in the refrigerant circuit.

According to an embodiment, the cooling unit 170 may include a compressor 171 for compressing the gaseous refrigerant, a condenser 172 for converting the compressed gaseous refrigerant into a liquid state, an expander 173 for decompressing the liquid refrigerant, and an evaporator 174 for converting the decompressed liquid refrigerant into a gaseous state. The cooling unit 170 may cool the air in the storage compartment using the phenomenon in which the liquid refrigerant absorbs thermal energy of the surrounding air while converting to the gaseous state.

However, the cooling unit 170 is not limited as including a refrigerant circuit. For example, the cooling unit 170 may include a Peltier element using the Peltier effect or a magnetic cooling material using a magnetic thermal effect.

According to an embodiment, the communication unit 180 may exchange data with external devices such as the server device and/or the user device and/or the display 195 and/or the cooking device.

According to an embodiment, the communication unit 180 may include a wired communication module 182 for wiredly exchanging data with external devices and a wireless communication module 181 for wirelessly exchanging data with external devices.

According to an embodiment, the wired communication module 182 may access a wired communication network and communicate with external devices through the wired communication network. For example, the wired communication module 182 may access the wired communication network through Ethernet (Ethernet, IEEE 802.3 technology standard) and receive data from the external devices through the wired communication network.

According to an embodiment, the wireless communication module 181 may wirelessly communicate with a base station or an access point (AP), and may access the wired communication network through the base station or the access point. The wireless communication module 181 may also communicate with the external devices connected to the wired communication network via the base station or the access point. For example, the wireless communication module 181 may wirelessly communicate with the access point (AP) using Wi-Fi (IEEE 802.11 technology standard), or communicate with the base station using CDMA, WCDMA, GSM, long term evolution (LET), or Wi-Bro. The wireless communication module 181 may also receive data from the external devices via the base station or the access point. Further, the wireless communication module 181 may directly communicate with the external devices. For example, the wireless communication module 181 may receive data wirelessly from the external devices using Wi-Fi, Bluetooth (IEEE 802.15.1 technology standard), ZigBee (IEEE 802.15.4 technology standard), etc.

According to an embodiment, the communication unit 180 may transmit or receive data with the external devices, and in particular, may receive video data including video and/or audio from the external devices and output the received data to the controller 190.

According to an embodiment, the controller 190 may process user input and/or door opening/closing detection data and/or communication data, and control the components included in the refrigerator 1 based on data processing.

According to an embodiment, the controller 190 includes a memory 192 that stores/records programs and/or data, and a processor 191 that processes user input and/or door opening/closing detection data and/or communication data according to the program and/or data stored in the memory 192.

According to an embodiment, the memory 192 may store/memory a program and/or data. The program includes a plurality of instructions combined to perform a specific function, and the data may be processed and/or treated by a plurality of instructions included in the program. Further, the program and/or data may include system programs and/or system data directly related to the operation of the refrigerator 1, and application programs and/or application data that provide convenience to the user.

According to an embodiment, the memory 192 may include a non-volatile memory storing a program and/or data for controlling the components included in the refrigerator 1 and a volatile memory storing temporary data generated during controlling the components included in the refrigerator 1.

According to an embodiment, the non-volatile memory may store programs and/or data, e.g., electrically, magnetically or optically. The non-volatile memory may include, e.g., a read only memory or flash memory for storing data for a long time. The non-volatile memory may also include a solid state drive (SSD), a hard disk drive (HDD), or an optical disc drive (ODD).

According to an embodiment, the volatile memory may load the program and/or data from the non-volatile memory, e.g., and may electrically store the program and/or data. The volatile memory may include, e.g., static random access memory (S-RAM) and dynamic random access memory (D-RAM) for temporarily storing data.

The memory 192 may store/record programs and data such as operating systems (OS), middleware, and applications, and may provide the programs and data to the processor 191 in response to a request of the processor 191.

According to an embodiment, the processor 191 may process a user input of the display 195 and detection data of the sensor unit 160, driving data of the door driver 150, and/or communication data of the communication unit 180 according to the program and/or data stored/recorded in the memory 192. The processor 191 may generate a control signal for controlling the sensor operation of the sensor unit 160, the driving of the door driver 150, and the operation of the communication unit 180 based on data processing.

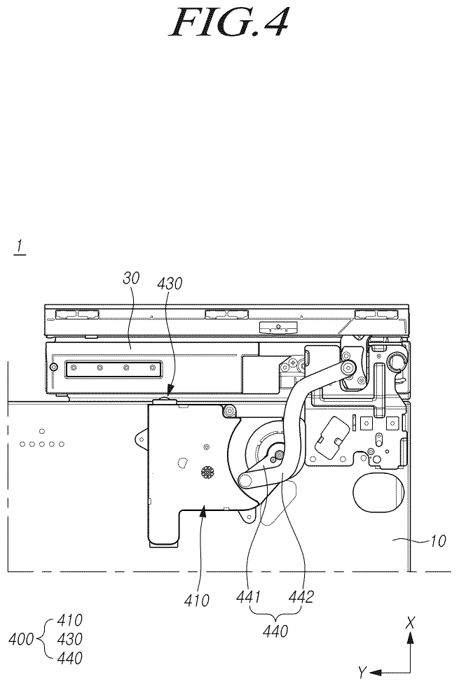

FIG. 4 is a view illustrating a door driver disposed in a top table and a door of a refrigerator according to an embodiment of the disclosure.

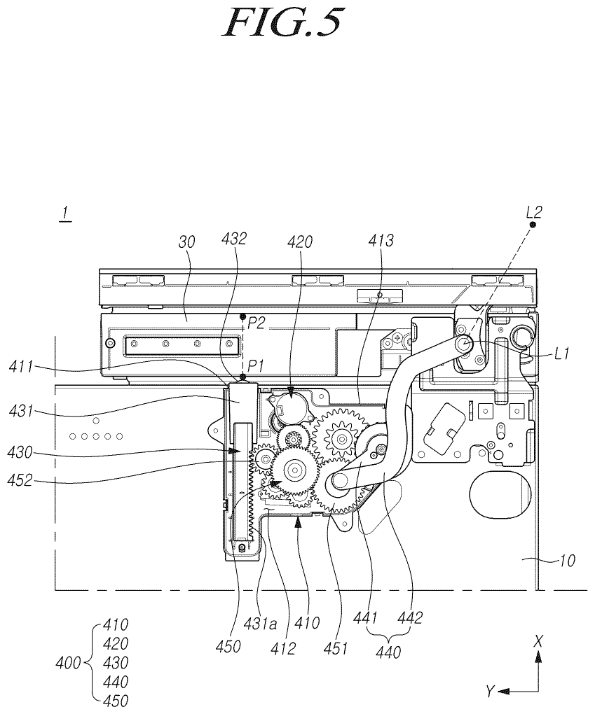

FIG. 5 is a view illustrating a pusher, a link, and gears disposed in the door driver of FIG. 3 according to an embodiment of the disclosure.

According to an embodiment, the refrigerator 1 may include a main body 10, a door 30, and/or a door driver 400. FIGS. 4 and 5 are views illustrating a portion of a main body 10 and a door 30 as viewed from above the refrigerator 1.

According to an embodiment, the configuration of the main body 10, the door 30, and the door driver 400 of the refrigerator 1 of FIGS. 4 and 5 may be identical in whole or part to the configuration of the main body 10, the door 30, and the door driver 150; 400 of the refrigerator 1 of FIGS. 1 to 3. The embodiments of FIGS. 4 and 5 may be selectively combined with the embodiments of FIGS. 1 to 3, and of FIGS. 4 to 25.

According to an embodiment, the refrigerator 1 may open or close the main body 10 (or the storage compartment 21) by the door 30. According to an embodiment, the door driver 400 of the refrigerator 1 may be provided to rotate the door 30 from the closed position toward the open position. For example, the door driver 400 may press the door 30 at the closed position to rotate the door 30 toward the open position. According to an embodiment, the door driver 400 of the refrigerator 1 may be provided to rotate the door 30 from the open position to the closed position. For example, the door driver 400 may pull the door 30 at the open position to rotate the door 30 toward the closed position.

According to an embodiment, the refrigerator 1 may automatically rotate the door 30 from the main body 10 ‘from the closed position to the open position’ or ‘from the open position to the closed position’ through the door driver 400.

According to an embodiment, the operation of opening the door 30 at a designated angle from the main body 10 (or the storage compartment 21) may be referred to as an ‘open operation of the refrigerator l’ and/or ‘open operation of the door 30’, and the operation of closing the door 30 at a designated angle from the main body 10 (or the storage compartment 21) may be referred to as a ‘close operation of the refrigerator 1’ and/or ‘close operation of the door 30’.

According to an embodiment, the state in which the door 30 is opened at a designated angle from the main body 10 (or the storage compartment 21) may be referred to as a ‘open state of the refrigerator l’ and/or ‘open state of the door 30’, and the state in which the door 30 is closed at a designated angle from the main body 10 (or the storage compartment 21) may be referred to as a ‘closed state of the refrigerator 1’ and/or ‘closed state of the door 30’.

According to an embodiment, the ‘open operation of the refrigerator 1 and/or the door 30’ may be divided into a ‘first open operation’ and a ‘second open operation’ according to the opening angle of the door 30 from the main body 10 (or the storage compartment 21). For example, the first open operation may be understood as an operation in which the door 30 is opened from the main body 10 in a first designated angle α range (e.g., an angle range of 0 degrees to 45 degrees or less). For example, the second open operation may be understood as an operation in which the door 30 is opened from the main body 10 in a second designated angle γ range (e.g., an angle range of about 45 degrees to 180 degrees or less).

According to an embodiment, the ‘open state of the refrigerator 1 and/or the door 30’ may be divided into a ‘first open state’ and a ‘second open state’ according to the opening angle of the door 30 from the main body 10 (or the storage compartment 21). For example, the first open state may be understood as a state in which the angle of the door 30 from the main body 10 is opened at the first designated angle α (e.g., an angle of about 45 degrees or less). For example, the second open state may be understood as a state in which the angle of the door 30 from the main body 10 is opened at the second designated angle γ (e.g., an angle between about 45 degrees and 180 degrees or less).

According to an embodiment, the first open operation (or state) may be referred to by various terms, such as at least one of an easy open operation (state), a narrow open operation (state), a limited open operation (state), and a restricted open operation (state).

According to an embodiment, the second open operation (or state) may be referred to by various terms, such as at least one of a wide open operation (state), a full open operation (state), an expansive open operation (state), and a broad open operation (state).

According to an embodiment, the door driver 400 may include at least one of a case 410, a power source (e.g., the motor 420), a pusher 430, a link 440, and a power transmission member (e.g., the gear 450).

According to an embodiment, the case 410 may receive at least a portion of the pusher 430, at least a portion of the link 440, a plurality of gears 450, and the motor 420. The case 410 may be mounted in a top table (e.g., the top table 13 of FIG. 1). The case 410 may include a fixing portion (not shown) coupled to the top table 13 and provided to be fixed to the main body 10. For example, the case 410 may be fixed to the top table 13 by a fastening member (e.g., a screw) that penetrates the fixing portion.

According to an embodiment, at least a portion of the pusher 430 is positioned in the case 410, and may be provided to press the door 30 to open the door 30. The pusher 430 may be supported by the case 410, and the case 410 may be fixed to the main body 10. As the door 30 is opened through the pusher 430, a first open operation (or a first open state) in which the door 30 is partially opened may be provided to the main body 10.

According to an embodiment, the pusher 430 may be provided to be movable from the main body 10 and/or the case 410. At least a portion of the pusher 430 may be formed to press the door 30 while sliding with respect to the main body 10 and/or the case 410. For example, the case 410 includes a first opening 411 formed to expose one end of the pusher 430, and a portion of the pusher 430 may reciprocate inside and outside the case 410 while passing through the first opening 411.

According to an embodiment, a portion of the pusher 430 (e.g., the moving rod 431) may be inserted into the receiving space 412 in the case 410 to be received in the receiving space 412, or may be withdrawn from the receiving space 412 to press the door 30. For example, the pusher 430 (e.g., hereinafter, one end of the pusher 430) may be provided to be movable between the first pusher position P1 and the second pusher position P2. For example, the pusher 430 may be provided to reciprocate between the first pusher position P1 and the second pusher position P2.

According to an embodiment, the first pusher position P1 may be a position of the pusher 430 when the door 30 is positioned in the closed state. The second pusher position P2 may be a position to which the pusher 430 moves from the first pusher position P1 in a direction of pressing the door 30. The pusher 430 moves from the first pusher position P1 to the second pusher position P2 to press and open the closed door 30. The second pusher position P2 may be a position to which the pusher 430 moves forward from the first pusher position P1.

According to an embodiment, the pusher 430 may be formed to be linearly movable between the first pusher position P1 and the second pusher position P2. The pusher 430 may be provided to be linearly movable in the front-rear direction X. However, the moving direction of the pusher 430 is not limited thereto, and the pusher 430 may move nonlinearly between the first pusher position P1 and the second pusher position P2.

According to an embodiment, the pusher 430 may press the door 30 until it reaches the second pusher position P2. Thereafter, the pusher 430 may stop moving based on reaching the second pusher position P2, or may move (e.g., return) to the first pusher position P1. In this case, the pusher 430 may no longer press the door 30.

According to an embodiment, the pusher 430 may include a moving rod 431 provided to be movable with respect to the main body 10. The moving rod 431 may be movable with respect to the case 410. The moving rod 431 may be supported by the case 410. At least a portion of the moving rod 431 may be received in the case 410. A portion of the moving rod 431 may be drawn in or out from the receiving space 412.

According to an embodiment, the pusher 430 may include a push roller 432. The push roller 432 may be mounted on one side of the moving rod 431 in a direction of pressing the door 30. When the pusher 430 moves from the first pusher position P1 to the second pusher position P2, the push roller 432 may come in contact with the door 30. For example, the door 30 may be directly pressed by the push roller 432.

According to an embodiment, the push roller 432 may be formed to be rotatable with respect to the moving rod 431. As the rotatable push roller 432 is positioned on one side of the moving rod 431, friction between the pusher 430 and the door 30 may be reduced, and the pusher 430 and the door 30 may be prevented from abrasion.

According to an embodiment, the door driver 400 includes a pusher 430 movable with respect to the main body 10 and provided to press the door 30, and may automatically open the door 30 through the pusher 430.

According to an embodiment, at least a portion of the link 440 is positioned within the case 410, and may be provided to press the door 30 to open the door 30. The link 440 may be supported by the case 410, and the case 410 may be fixed to the main body 10.

According to an embodiment, the link 440 may be disposed to connect the main body 10 and the door 30 and include a first link portion 441 and a second link portion 442 rotatably connected from one end of the first link portion 441. The second open operation (or the second open state) in which the door 30 is completely opened from the main body 10 may be provided through the link 440. For example, after the door 30 is opened by the pusher 430, the door 30 may be additionally opened through the link 440 to provide the second open operation (or the second open state). For example, after the door 30 is opened by the link 440, the door 30 may be additionally opened through the link 440 to provide the second open operation (or the second open state).

According to an embodiment, the link 440 may be provided to be rotatable from the main body 10 and/or the case 410. The first link portion 441 of the link 440 may be rotatably connected with respect to the rotation shaft of the link gear 451 among the gears 450. For example, one end of the first link portion 441 may be rotatably connected to the link gear 451, and the other end may be rotatably connected to the second link portion 442. The second link portion 442 of the link 440 may be rotatably connected to the door 30, to transfer a force received from the link gear 451 and the first link portion 441 to the door 30 to open the door 30.

According to an embodiment, a portion of the link 440 (e.g., the second link portion 442) may be formed to press the door 30 while rotating with respect to the case 410 and open the door 30 at a designated angle or more from the main body 10. The case 410 may include a second opening 413 formed to expose a portion of the second link portion 442 of the link 440, and a portion of the second link portion 442 may move inside and outside the case 410 while passing through the second opening 413.

According to an embodiment, the first link portion 441 of the link 440 may be inserted into the receiving space 412 in the case 410 and rotated while being received in the receiving space 412. A portion of the second link portion 442 of the link 440 may be inserted into the receiving space 412 in the case 410 or may be withdrawn from the receiving space 412 to press the door 30. For example, one end of the second link portion 442 may be provided to be movable between the first link position L1 and the second link position L2. For example, one end of the second link portion 442 may be provided to be movable between the first link position L1 and the second link position L2.

According to an embodiment, the first link position L1 may be a position of one end of the second link portion 442 in a state in which the door 30 is closed. The second link position L2 may be a position of one end of the second link portion 442 in a state in which the door 30 is opened. When one end of the second link portion 442 is at the second link position L2, the door 30 may be opened by 90 degrees or more from the main body 10. According to an embodiment, the position of one end of the second link portion 442 may move from the first link position L1 to the second link position L2 to press to open the closed door 30 or to further open the opened door 30. The second pusher position P2 may be a position to which the pusher 430 moves forward and laterally from the first link position L1.

According to an embodiment, the link 440 may be formed to be nonlinearly movable between the first link position L1 and the second link position L2. The first link portion 441 and the second link portion 442 may be a component rotatably connected, and the second link portion 442 is a curved line-shaped plate, and the moving direction may be nonlinear.

According to an embodiment, the link 440 may press the door 30 until the second link position L2 is reached. Thereafter, one end of the second link portion 442 may stop moving based on reaching the second link position L2 or may move (e.g., return) to the first link position L1. In this case, the link 440 may no longer press the door 30.

According to an embodiment, the door driver 400 includes a link 440 movable with respect to the main body 10 and provided to press the door 30, and may automatically open the door 30 through the link 440.

According to an embodiment, the motor 420 may generate power for the pusher 430 and/or the link 440 to move. For example, the motor 420 may transfer power required for the pusher 430 when the pusher 430 moves between the first pusher position P1 and the second pusher position P2. The motor 420 may transfer power required for the link 440 when the link 440 moves between the first link position L1 and the second link position L2.

According to an embodiment, the motor 420 may include a driving motor and a motor driver connected to the driving motor. The driving motor may generate power by receiving a driving current from the motor driver. The motor driver may be electrically connected to a controller (e.g., the controller 190 of FIG. 3) of the refrigerator 1, and may operate based on a control signal received from the controller.

According to an embodiment, the motor 420 may be supported by the case 410. The motor 420 may be received in the case 410.

According to an embodiment, the gear 450 may transfer power generated by the motor 420 to the pusher 430 and/or the link 440. The gear 450 may be supported by the case 410. The gear 450 may be disposed in the receiving space 412 in the case 410.

According to an embodiment, the pusher 430 may have a structure capable of receiving power from the gear 450. For example, the structure capable of receiving power from the gear 450 may be formed on the moving rod 431. The power generated by the motor 420 may be transferred to the moving rod 431 and the push roller 432 through the gear 450.

According to an embodiment, the link 440 may have a structure capable of receiving power from the gear 450. For example, the structure capable of receiving power from the gear 450 may be formed on the first link portion 441. The power generated by the motor 420 may be transferred to the first link portion 441 and the second link portion 442 through the link gear 451.

According to an embodiment, the gear 450 may include a plurality of gears.

According to an embodiment, the moving rod 431 may include a rod gear part 431a engaged with the pinion gear 452 among the gears 450, and the rod gear part 431a may receive power from the pinion gear 452 and the gear(s) engaged with the pinion gear 452. For example, the pinion gear 452 and the rod gear part 431a may form a rack-pinion gear structure, and the moving rod 431 may move linearly with respect to the case 410.

According to an embodiment, the first link part 441 may have the same rotation shaft as the link gear 451 of the gear 450 and may be connected, and the link gear 451 may receive power from the gear(s) engaged with the link gear 451. The power transferred to the first link part 441 may rotate the first link part 441 in the forward or reverse direction.

According to an embodiment, the motor 420 may be controlled by a controller (e.g., the controller 190 of FIG. 3) of the refrigerator 1. The motor 420 may be electrically connected to the controller 190. The controller 190 may transmit a control signal for controlling the motor 420 to the motor 420, and the motor 420 may operate based on the control signal received from the controller.

According to an embodiment, the controller 190 of the refrigerator 1 may control the motor 420 to move the pusher 430 from the first pusher position P1 to the second pusher position P2 based on a condition for opening the door 30. For example, the condition for opening the door 30 may include obtaining a user input for opening the door 30.

According to an embodiment, the controller 190 of the refrigerator 1 may control the motor 420 to move the link 440 from the first link position L1 to the second link position L2 based on a condition for opening the door 30. For example, the condition for opening the door 30 may include obtaining a user input for opening the door 30.

According to an embodiment, the refrigerator 1 may include a user interface including an input button. For example, the input button may be provided to obtain a user input for opening the door 30.

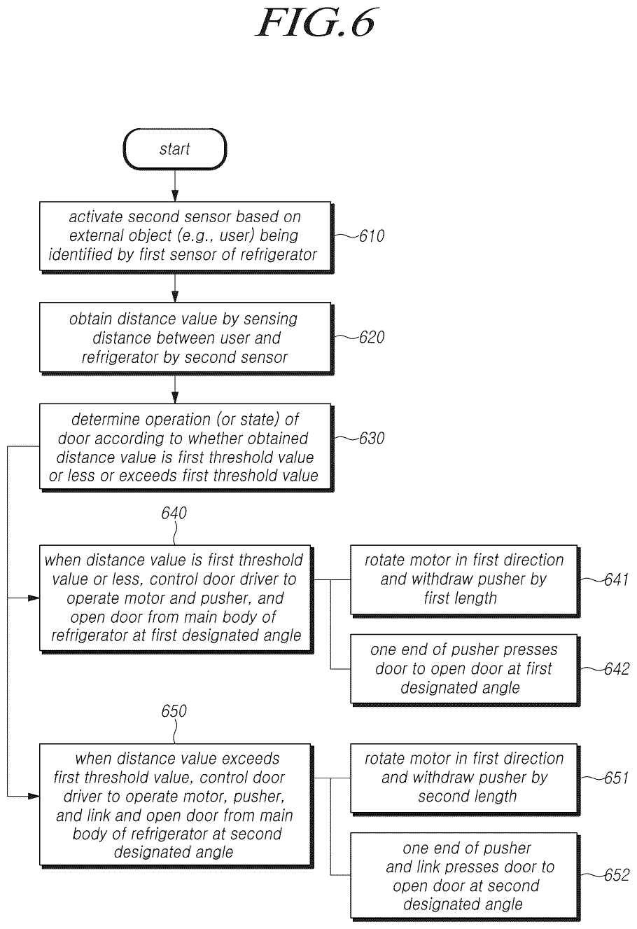

FIG. 6 is a flowchart illustrating an open operation of a door from a main body according to an embodiment of the disclosure.

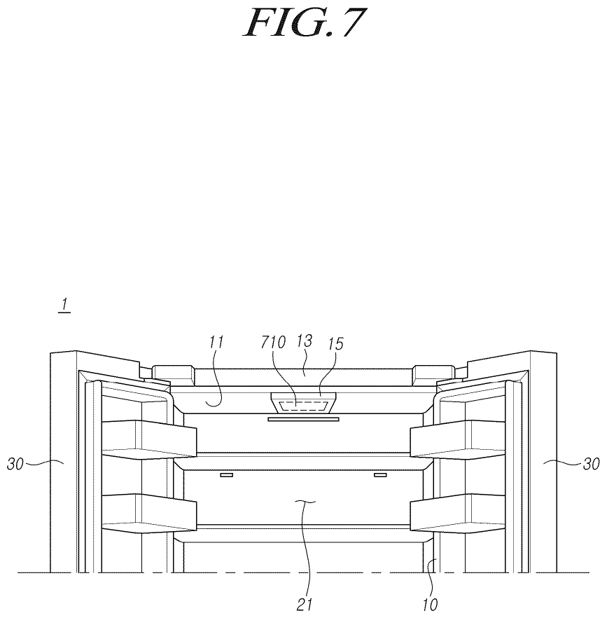

FIG. 7 is a view illustrating a position of a first sensor of a refrigerator according to an embodiment of the disclosure.

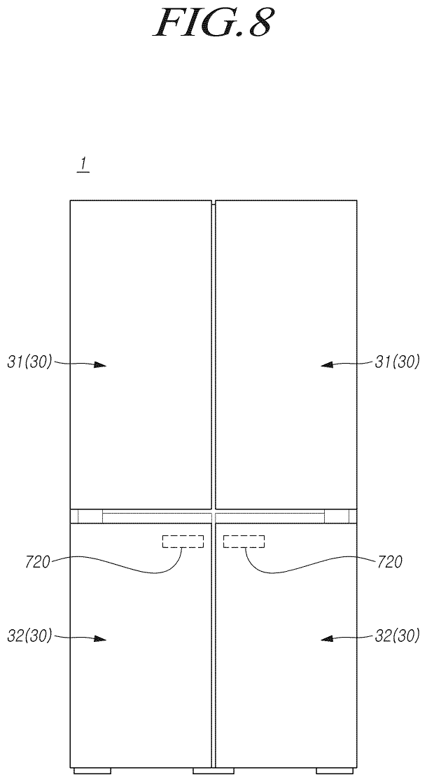

FIG. 8 is a view illustrating a position of a second sensor of a refrigerator according to an embodiment of the disclosure.

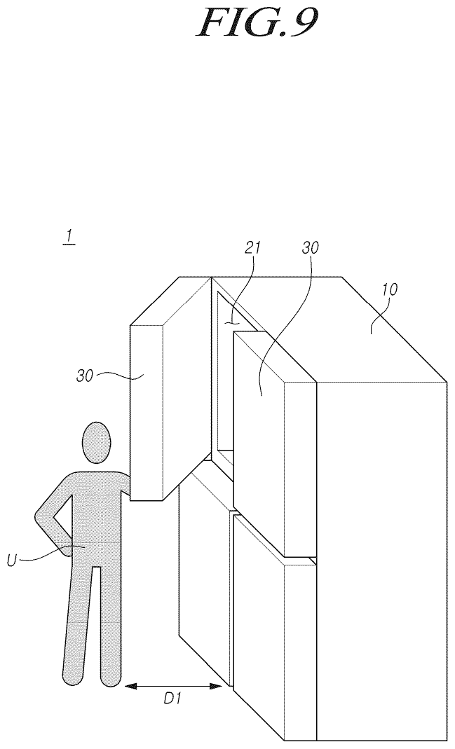

FIG. 9 is a view illustrating a first open state of a refrigerator and a distance between the refrigerator and an external object (e.g., the user) according to an embodiment of the disclosure.

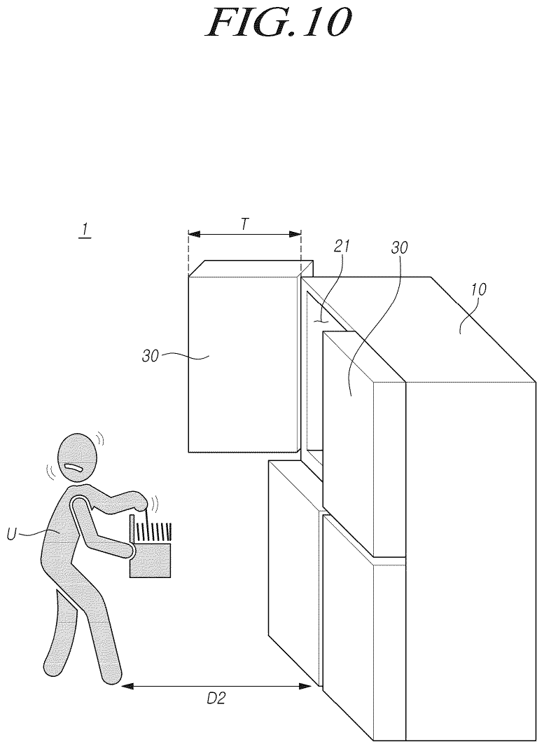

FIG. 10 is a view illustrating a second open state of a refrigerator and a distance between the refrigerator and an external object (e.g., the user) according to an embodiment of the disclosure.

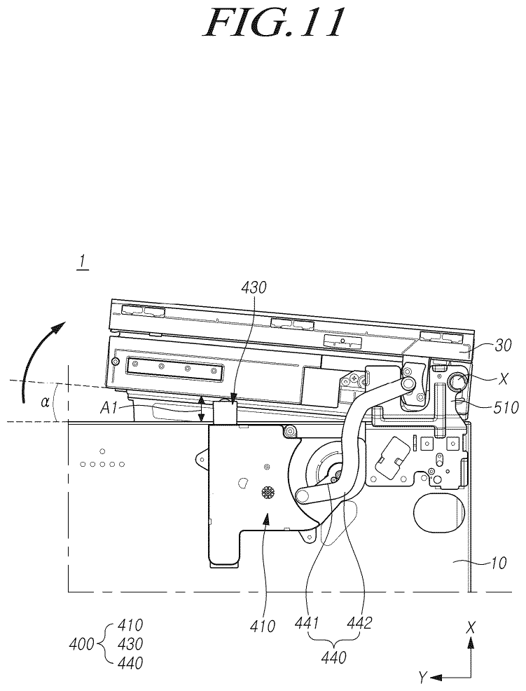

FIG. 11 is a view illustrating a first open state of a refrigerator as viewed from above the refrigerator according to an embodiment of the disclosure.

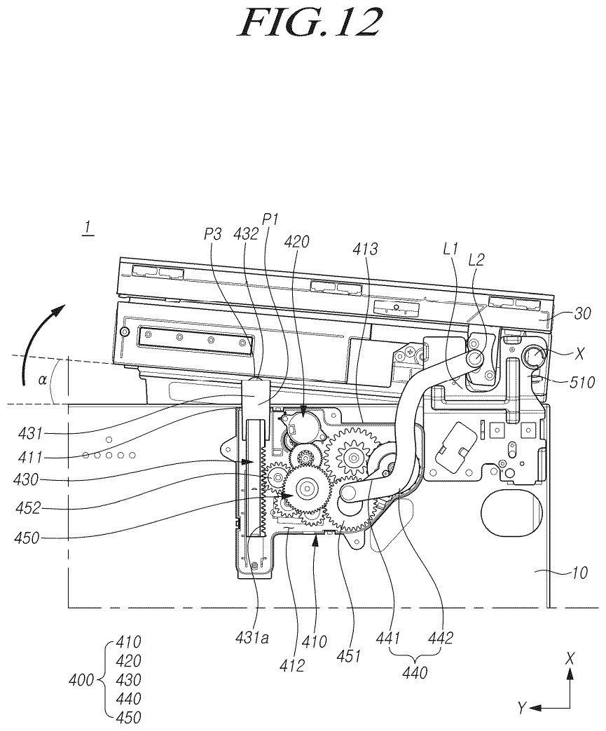

FIG. 12 is a see-through view illustrating a door driver in a first open state of the refrigerator of FIG. 10 according to an embodiment of the disclosure.

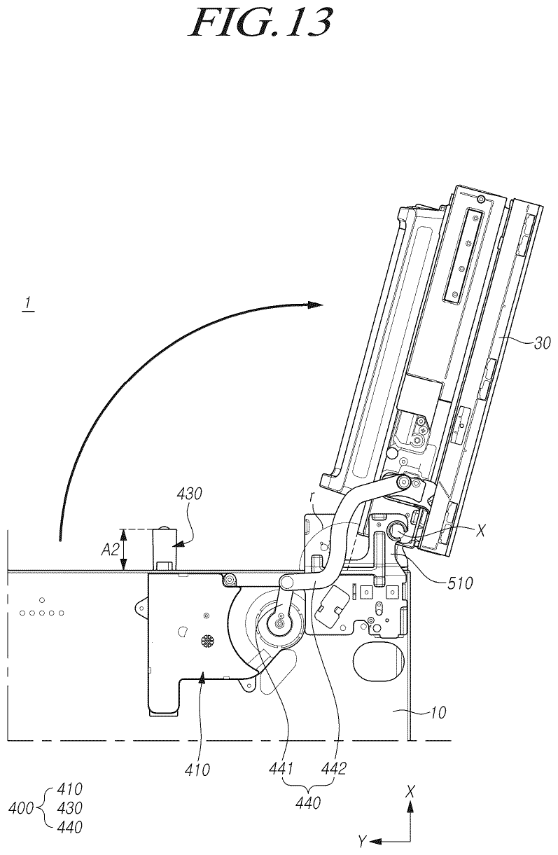

FIG. 13 is a view illustrating a second open state of a refrigerator as viewed from above the refrigerator according to an embodiment of the disclosure.

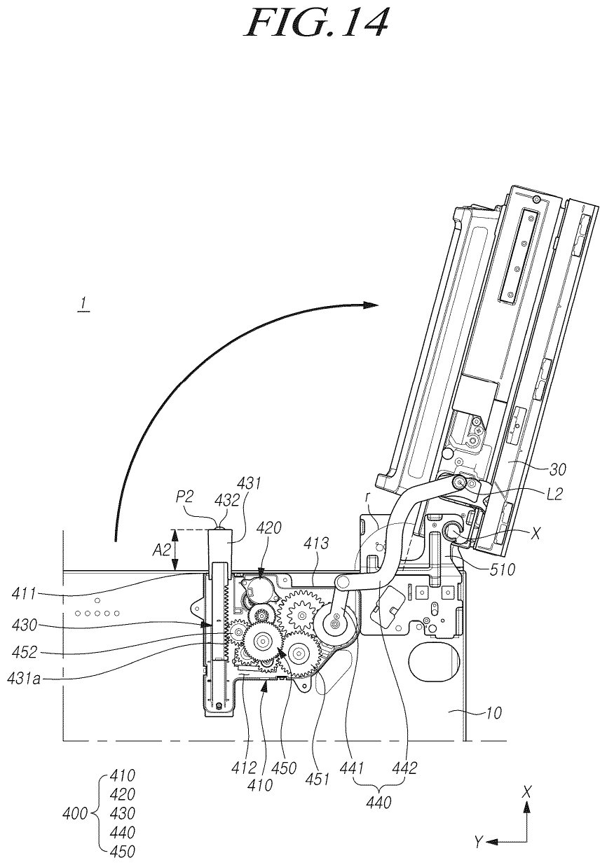

FIG. 14 is a see-through view illustrating a door driver in a second open state of the refrigerator of FIG. 12 according to an embodiment of the disclosure.

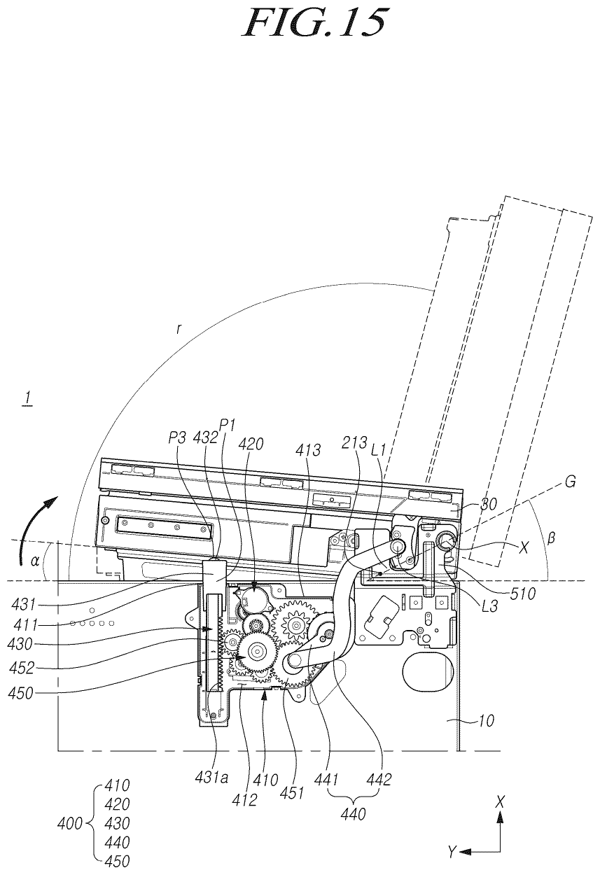

According to an embodiment, the configuration of the main body 10, the door 30, and the door driver 400 of the refrigerator 1 of FIGS. 6 to 14 may be identical in whole or part to the configuration of the main body 10, the door 30, and the door driver 150; 400 of the refrigerator 1 of FIGS. 1 to 5. The embodiments of FIGS. 6 to 14 may be selectively combined with the embodiments of FIGS. 1 to 5, and the embodiments of FIGS. 15 to 25.

According to an embodiment, the door driver 400 may include at least one of a case 410, a motor 420, a pusher 430, a link 440, and gears 450.

Referring to FIGS. 6 to 14, the refrigerator 1 of the disclosure may automatically open the door 30 that meets the intention of the user U by identifying an external object (e.g., the user U) using a plurality of sensors (e.g., the first sensor 710 and the second sensor 720) and the door driver 400, detecting the distance between the refrigerator 1 and the user U, and opening at different opening angles of the door 30 with respect to the refrigerator 1.

According to an embodiment, the refrigerator 1 includes at least one sensor, and at least one processor may open the door 30 from the main body 10 at a designated angle (e.g., the first designated angle α or a second designated angle γ) based on the data value obtained by the sensor. For example, in the closed state of the door 30, at least one processor may determine whether the sensing data value obtained by the sensor is smaller than or equal to a first threshold value. At least one processor may control the door driver to open the door 30 from the main body 10 at the first designated angle α based on determining that the sensing data value is smaller than or equal to the first threshold value. At least one processor may control the door driver to open the door 30 from the main body 10 at a second designated angle γ larger than the first designated angle α based on determining that the sensing data value exceeds the first threshold value. According to an embodiment, the sensor may include a first sensor 710 and/or a second sensor 720.

According to an embodiment, in operation 610, when an external object (e.g., the user U) approaches the refrigerator 1, the refrigerator 1 may identify the user by the first sensor 710 and, based thereon, activate the second sensor 720. According to an embodiment, in the closed state of the door 30, at least one processor (e.g., the processor 191 of FIG. 3) of the refrigerator 1 may identify the user U through the first sensor 710 and control the second sensor 720 to operate.

According to an embodiment, the first sensor 710 is a trigger sensor, and may include at least one of a touch pressure sensor that senses whether the user U has touched (e.g., pressed) the refrigerator 1, a detection sensor that may identify the user (e.g., a proximity sensor that detects whether the user is close to the refrigerator 1), a voice recognition sensor (e.g., a microphone or a speaker) that senses the user U's voice, and a motion sensor that senses the user U's motion. In addition to the disclosed sensors, the first sensor 710 may be design-changed to various sensors that identify the user and activate the second sensor 720.

For example, when the first sensor 710 is a touch pressure sensor, at least one processor 191 of the refrigerator 1 may obtain a touch pressure value by the external object (e.g., the user U) on the door 30 through the first sensor 710 and, upon determining that the obtained touch pressure value is a designated threshold value or more, control the second sensor 720 to operate.

According to an embodiment, the first sensor 710 may be disposed on one side of the main body 10 and/or the door 30 to face in the front direction. The first sensor 710 may be positioned in a place where the user's approach/touch/voice may be easily recognized. Referring to FIG. 7, the first sensor 710 may be positioned on one side of the inner housing 11. For example, it may be positioned adjacent to the upper end of the first storage compartment 21 and/or the rotating bar guide 15. However, the position of the first sensor 710 is not limited to the position of the disclosed drawings, and may be variously design-changed to a place where the user's approach/touch/voice may be easily sensed.

According to an embodiment, in operation 620, the refrigerator 1 may obtain a distance value by sensing a distance between an external object (e.g., the user U) and the refrigerator 1 by the second sensor 720. According to an embodiment, in the closed state of the door 30, at least one processor 191 of the refrigerator 1 may obtain a distance value between the main body 10 and the user through the second sensor 720.

According to an embodiment, the refrigerator 1 may identify the position of the user U at a predetermined distance from the door 30.

According to an embodiment, the second sensor 720 may be a distance sensor. The refrigerator 1 may control the door driver 400 by determining when the distance between the users from the main body 10 is smaller than the first threshold value and when the distance is larger than or equal to the first threshold value through the second sensor 720.

According to an embodiment, the second sensor 720 may be disposed on one side of the main body 10 and/or the door 30 to face in the front direction. Referring to FIG. 8, the second sensor 720 may be positioned at an outer lower end of the door 30 to easily recognize the user's position. The second sensor 720 may be positioned outside the upper door and/or the lower door. For example, when the user opens the upper door, the second sensor 720 may be disposed adjacent to the upper end or lower end of the lower door to facilitate distance measurement. However, the position of the second sensor 720 is not limited to the position of the disclosed drawings, and may be variously design-changed to a place where the position of the user U may be easily sensed.

According to an embodiment, in operation 630, the refrigerator 1 may determine the operation (or state) of the door 30 separately for the case where the obtained distance value is the first threshold value or less and the case where the obtained distance value exceeds the first threshold value. According to an embodiment, in the closed state of the door 30, at least one processor 191 of the refrigerator 1 may control the door driver 400 to make the door 30 in different open states by distinguishing between when the distance value obtained by the second sensor 720 is smaller than or equal to the first threshold value and when the distance value exceeds the first threshold value.

According to an embodiment, when the distance value obtained using the second sensor 720 is smaller than or equal to the first threshold value, the refrigerator 1 may determine to control the door driver 400 to open the door 30 from the main body 10 at a first designated angle α. Referring to FIG. 9, when the distance between the user U and the refrigerator 1 is a first distance D1 which is the first threshold value or less in a state in which the user U touches the refrigerator 1, the refrigerator 1 may determine to open the door 30 from the main body 10 at the first designated angle α.

According to an embodiment, the first threshold value may be about 0.2m to 0.8 m. For example, the first threshold value may be about 0.5 m. When the distance between the user U and the refrigerator 1 is the first distance D1 equal to or smaller than the first threshold value, the first distance D1 may be smaller than the width T of the door 30.

According to an embodiment, the first designated angle α may be one of angles according to the first open operation of the door 30. The first designated angle α may be an angle in the first open state of the door 30. For example, the first designated angle α may be one of about 45 degrees or less. For example, the first designated angle α may be one of about 20 degrees or less.

According to an embodiment, when the distance value obtained using the second sensor 720 exceeds the first threshold value, the refrigerator 1 may determine to control the door driver 400 to open the door 30 from the main body 10 at a second designated angle γ. Referring to FIG. 10, when the distance between the user U and the refrigerator 1 is the second distance D2 exceeding the first threshold value while the user U has an object in both hands, the refrigerator 1 may determine to open the door 30 from the main body 10 at the second designated angle γ.

According to an embodiment, the first threshold value may be about 0.2 m to 0.8 m. For example, the first threshold value may be about 0.5 m. When the distance between the user U and the refrigerator 1 is the second distance D2 which is larger than the first threshold value, the second distance D2 may be larger than the width T of the door 30.

According to an embodiment, the second designated angle γ may be one of angles according to the second open operation of the door 30. The second designated angle γ may be an angle in the second open state of the door 30. For example, the second designated angle γ may be one of about 45 degrees or more and 180 degrees or less. For example, the first designated angle α may be one of smaller than about 120 degrees.

According to an embodiment, in operation 640, when the distance value obtained using the second sensor 720 is smaller than or equal to the first threshold value, the refrigerator 1 may open the door 30 by controlling the door driver 400 (e.g., the pusher 430). Operation 640 may be defined as a first open operation and/or a first open state according to the first open operation of the door 30. The first open operation and the first open state may be understood as an operation and state for opening the door 30 from the main body 10 at an angle of about 45 degrees or less.

According to an embodiment, when the distance value obtained using the second sensor 720 is smaller than or equal to the first threshold value, the refrigerator 1 may perform the first open operation by driving the door driver 400. The door driver 400 may include a motor 420, a pusher 430 which provides a force to open the door 30, and a gear 450 for transferring power from the motor 420 to the pusher 430. The refrigerator 1 may rotate the motor 420 and transfer power to the pusher 430 through the gear 450 by the rotation of the motor 420. The pusher 430 may press the door 30 of the refrigerator 1 while moving in the front direction (e.g., the X-axis direction), and the door 30 may be opened by the first designated angle α.

According to an embodiment, in operation 641, the refrigerator 1 may rotate the motor 420 in the first direction (e.g., the forward rotation), and may withdraw a portion of the pusher 430 (e.g., the first length A1) from the main body 10.

According to an embodiment, in operation 642, as the withdrawn one end of the pusher 430 presses the door 30, the door 30 may be opened from the main body 10.

According to an embodiment, when the distance value obtained using the second sensor 720 is smaller than or equal to the first threshold value, the at least one processor 191 may open the door 30 at the first designated angle α (e.g., about 45 degrees or less) by controlling the driving of the door driver 400. The door driver 400 may move the pusher 430 from the first pusher position P1 toward the third pusher position P3, and may press to open the closed door 30. The pusher 430 may press the door 30 until it reaches the third pusher position P3. Thereafter, the pusher 430 may stop moving based on reaching the third pusher position P3, or may move (e.g., return) to the first pusher position P1. In this case, the pusher 430 may no longer press the door 30. One end of the second link portion 442 of the link 440 is configured to move from a first link position L1 toward a third link position L3.

According to an embodiment, the pusher 430 may include a moving rod 431 movable with respect to the main body 10 and a push roller 432 disposed at one end of the moving rod 431 to contact the door 30. In the first open operation, a portion of the movement rod 431 may move while being withdrawn from the receiving space 412 of the case 410, and the push roller 432 may directly contact the door 30 to push the door 30 in the front direction.

According to an embodiment, the main body 10 and the door 30 may be rotatably connected through a hinge 510. For example, the hinge 510 may be rotatably coupled to the main body 10, and the door 30 may rotate around the door rotation shaft X positioned within the hinge 510 and may be opened from the main body 10. In the first open operation, the door 30 rotates about the door rotation shaft X, and may rotate so that the door 30 is opened from the main body 10 by the first designated angle α.

According to an embodiment, the pusher 430 and the gear engaged therewith may provide a rack-pinion gear structure, the rack (e.g., the moving rod 431) of the pusher 430 may include a rod gear part 431a, and the gear 450 receiving power from the motor 420 may include a pinion gear 450. The rod gear part 431a and the pinion gear 450 may be engaged and rotated, and as the pinion gear 450 having a fixed position rotates in the first direction (e.g., the forward rotation), the pusher 430 may move in the front direction (e.g., the X-axis direction).

According to an embodiment, in the first open operation, the pusher 430 may be exposed by the first length A1 from the main body 10 to open the door 30. For example, when the total length L where the pusher 430 may be exposed from the main body 10 is L, the pusher 430 may be withdrawn by a first length A1 which is a portion of L, pushing the door 30. The first length A1 may be understood as a distance gap between the main body 10 and the door 30 spaced apart by the pusher 430 as the door 30 has a first designated angle α from the main body 10.

According to an embodiment, after the first open operation is completed, the pusher 430 may move to be drawn into the receiving space 412 of the case 410 by itself. For example, the pusher 430 includes an elastic member (not shown) that provides elastic force in the rear direction, and if the transmission of power from the pusher 430 disappears, the elastic member may return the pusher 430 to its original position (e.g., within the receiving space 412 of the case 410 or to the first pusher position P1).

According to an embodiment, after the first open operation is completed, the pusher 430 may move to be drawn into the receiving space 412 of the case 410 by the control of the door driver 400. For example, the refrigerator 1 may rotate the motor 420 in the second rotation direction (e.g., the reverse rotation) to rotate the pinion gear 452 engaged with the pusher 430, and in conjunction therewith, return the pusher 430 to its original position (e.g., within the receiving space 412 of the case 410 or to the first pusher position P1).

According to an embodiment, in operation 650, when the distance value obtained using the second sensor 720 exceeds the first threshold value, the refrigerator 1 may open the door 30 by controlling the door driver 400 (e.g., the pusher 430 and the link 440). Operation 650 may be defined as a second open operation and/or a second open state according to the second open operation of the door 30. The second open operation and the second open state may be understood as an operation and state for opening the door 30 from the main body 10 at one of angles larger than about 45 degrees and smaller than or equal to 180 degrees.

According to an embodiment, when the distance value obtained using the second sensor 720 exceeds the first threshold value, the refrigerator 1 may perform the second open operation by driving the door driver 400. The door driver 400 may include a motor 420, a pusher 430 and a link 440 which provide a force to open the door 30, and a gear 450 for transferring power from the motor 420 to the pusher 430 and the link 440.

According to an embodiment, in operation 651, the refrigerator 1 may rotate the motor 420 in the first direction (e.g., the forward rotation), and may withdraw a portion (e.g., a second length A2) of the pusher 430 from the main body 10. The refrigerator 1 may rotate the motor 420 in the first direction (e.g., the forward rotation), and may withdraw a portion of the link 440 from the main body 10.

According to an embodiment, in operation 652, as one end of the withdrawn pusher 430 and one end of the link 440 (e.g., the second link part 442) press the door 30, the door 30 may be opened from the main body 10.

According to an embodiment, the second open operation may use the pusher 430 and the link 440 to open the door 30. For example, the refrigerator 1 may rotate the motor and transfer power to the pusher 430 through the gear 450 by the rotation of the motor. The pusher 430 may press the door 30 of the refrigerator 1 while moving in the front direction (e.g., the X-axis direction), and the door 30 may be opened. Thereafter, the refrigerator 1 may rotate the motor and transfer power to the link 440 through the gear 450 by the rotation of the motor. The link 440 may press the door 30 to further extend the opening range of the door 30 from the main body 10. The link 440 may further open the door 30 opened by the pusher 430 from the main body 10. The power transmission order is an example, and the refrigerator 1 may perform the second open operation by sequentially transferring the power transferred from the motor to the pusher 430 and the link 440 or simultaneously transferring the power.

According to an embodiment, the link 440 may include a first link portion 441 and a second link portion 442. The first link portion 441 may be rotatably connected to the main body 10, the second link portion 442 may be rotatably connected to the door 30, and the first link portion 441 and the second link portion 442 may be connected to be rotatable with respect to each other. In the second open operation, the first link portion 441 receiving power from the motor 420 rotates so that the portion connected to the second link portion 442 is positioned to face in the front direction, and the second link portion 442 is withdrawn from the receiving space 412 of the case 410 and moves in the front direction while pressing the door 30 coupled to one end of the second link portion 442, expanding the area in which the main body 10 is opened.

According to an embodiment, the refrigerator 1 may be opened to become the second open state through the link 440 of the door driver 400. The second open state may be an angle at which it is easy for the user U to load or take out items in the storage compartment 21 of the refrigerator 1.

According to an embodiment, when the distance value obtained using the second sensor 720 exceeds the first threshold value, the at least one processor 191 may control the driving of the door driver 400 to open the door 30 at a second designated angle γ (e.g., one of about 45 degrees or more and 180 degrees or less). According to an embodiment, the door driver 400 may move the pusher 430 and the link 440.

For example, the door driver 400 may move the pusher 430 from the first pusher position P1 toward the second pusher position P2 and press to open the closed door 30. The second pusher position P2 may be a position having a length increased in the front direction (e.g., the X-axis direction) from the main body 10 as compared with the third pusher position P3. The pusher 430 may press the door 30 until it reaches the second pusher position P2. The length of the exposed portion of the pusher 430 may be the second length A2. The pusher 430 may stop moving based on reaching the second pusher position P2, or may move (e.g., return) to the first pusher position P1. Thereafter, the door driver 400 may move one end of the second link portion 442 of the link 440 from the first link position L1 toward the second link position L2, and may further open the opened door 30. The link 440 may press the door 30 until the second link position L2 is reached. The link 440 may stop moving based on reaching the second link position L2. In this case, the link 440 may no longer press the door 30.

According to an embodiment, the main body 10 and the door 30 may be rotatably connected through a hinge 510. For example, the hinge 510 may be rotatably coupled to the main body 10, and the door 30 may rotate around the door rotation shaft X positioned within the hinge 510 and may be opened from the main body 10. In the second open operation, the door 30 rotates about the door rotation shaft X, and may rotate so that the door 30 is opened from the main body 10 by the second designated angle γ.

According to an embodiment, the first link portion 441 of the link 440 may be rotated in conjunction with the gear (e.g., the link gear 451) engaged therewith. The gear 450 receiving the power from the motor 420 may include a link gear 451. For example, a plurality of gears may be disposed to be engaged with each other to rotate between the motor 420 and the link gear 451 and, as the position-fixed link gear 451, receiving power through the motor 420 and the plurality of gears 450, rotates in the first direction (e.g., the forward rotation), one end of the first link portion 441 may rotate in the front direction. The second link portion 442 connected to the first link portion 441 may partially rotate in the front direction and move, and may push the door 30 to open the door.

According to an embodiment, in the second open operation (e.g., when the refrigerator 1 performs the second open operation using the pusher 430 and the link 440 of the door driver 400), the pusher 430 is exposed by the second length A2 from the main body 10 to open the door 30. For example, when the total length L in which the pusher 430 may be exposed from the main body 10, L and the second length A2 may be the same, the pusher 430 may be withdrawn by the second length A2 to push the door 30 and, as the door 30 forms the second designated angle γ from the main body 10, the second length A2 may be understood as a gap between the door 30 and the main body 10 spaced apart by the pusher 430. The second length A2 may be larger than the first length A1.

According to an embodiment, the pusher 430 may include a moving rod 431 movable with respect to the main body 10 and a push roller 432 disposed at one end of the moving rod 431 to contact the door 30. In the second open operation, a portion of the movement rod 431 may move while being withdrawn from the receiving space 412 of the case 410, and the push roller 432 may directly contact the door 30 to push the door 30 in the front direction.

According to an embodiment, after the second open operation is completed, the pusher 430 may move to be drawn into the receiving space 412 of the case 410 by itself. For example, the pusher 430 includes an elastic member (not shown) that provides elastic force in the rear direction, and if the transmission of power from the pusher 430 disappears, the elastic member may return the pusher 430 to its original position (e.g., within the receiving space 412 of the case 410 or to the first pusher position P1).

According to an embodiment, after the second open operation is completed, the pusher 430 may move to be drawn into the receiving space 412 of the case 410 by the control of the door driver 400. For example, the refrigerator 1 may rotate the motor 420 in the second rotation direction (e.g., the reverse rotation) to rotate the pinion gear 452 engaged with the pusher 430, and in conjunction therewith, return the pusher 430 to its original position (e.g., within the receiving space 412 of the case 410 or to the first pusher position P1).

FIG. 15 is a see-through view illustrating an upper side of a refrigerator for comparison with a curve angle when a door is at a first designated angle α from a main body according to an embodiment of the disclosure.

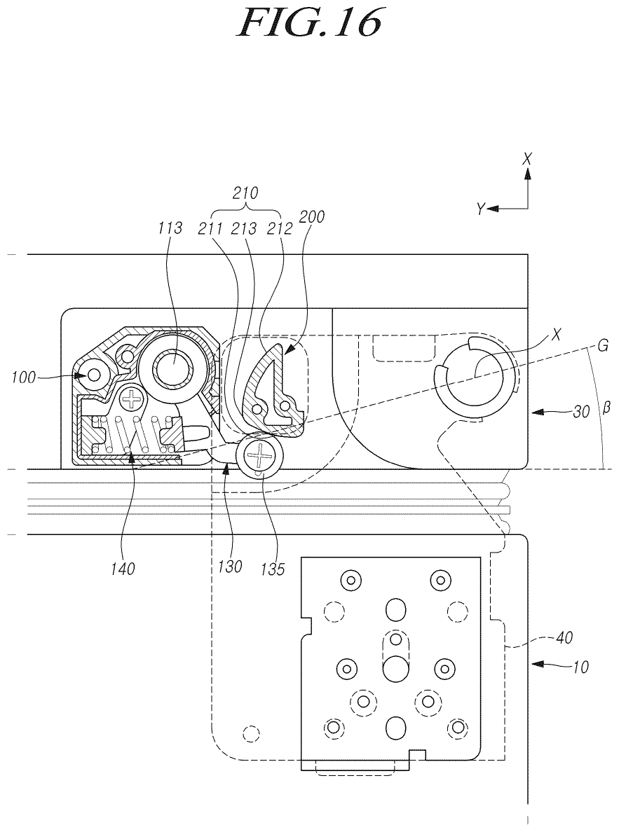

FIG. 16 is a view illustrating a guide and a lever device when a door is at a closed position in a refrigerator according to an embodiment of the disclosure.

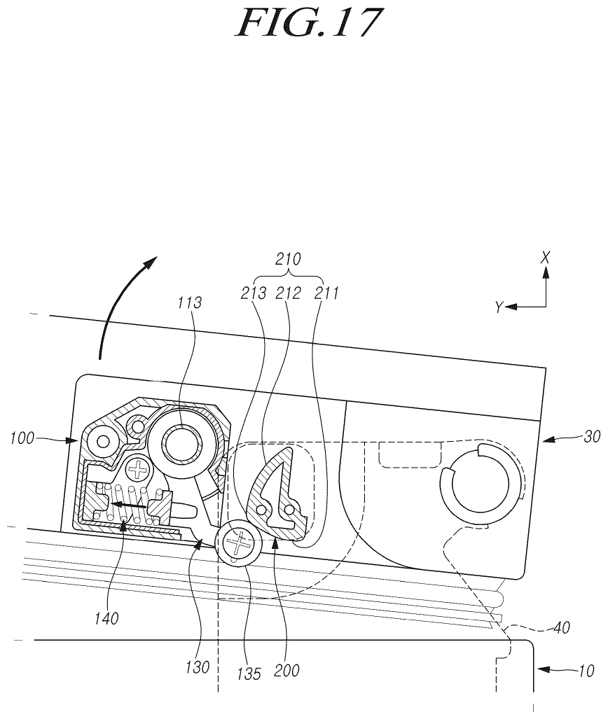

FIG. 17 is a view illustrating a state in which when a door is opened in a refrigerator, a roller of a lever device moves along a first contact surface of a guide according to an embodiment of the disclosure.

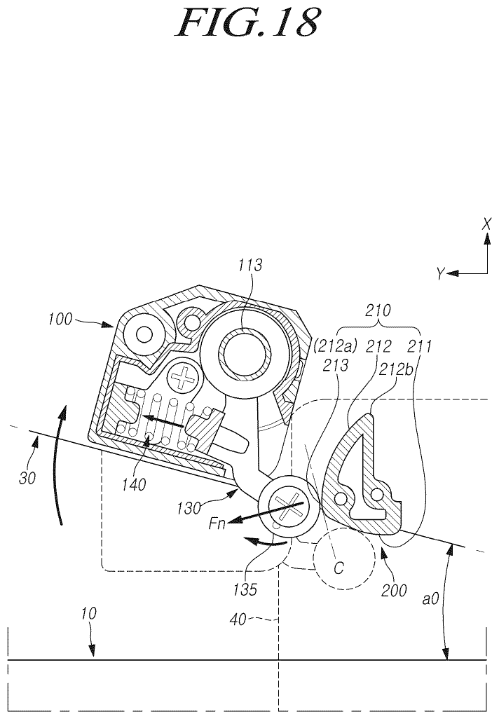

FIG. 18 is a view illustrating a state in which a roller of a lever device contacts a curve point of a guide according to an embodiment of the disclosure.

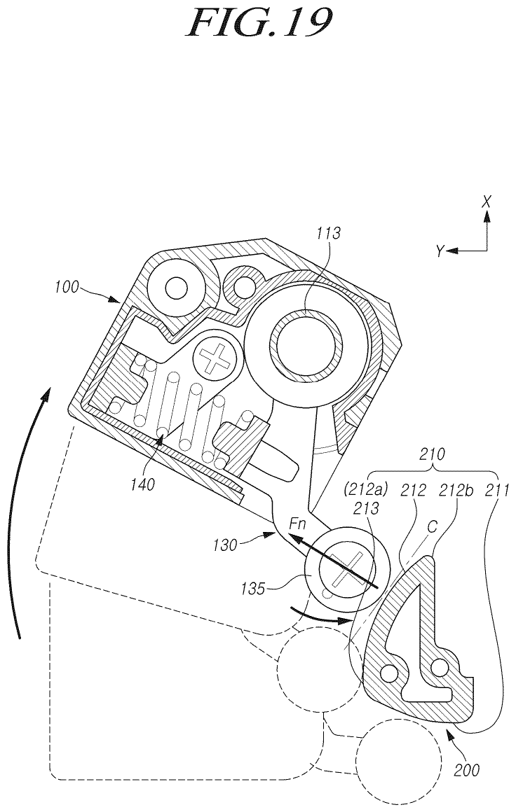

FIG. 19 is a view illustrating a state in which when a door is opened in a refrigerator, a roller of a lever device moves along a second contact surface of a guide according to an embodiment of the disclosure.

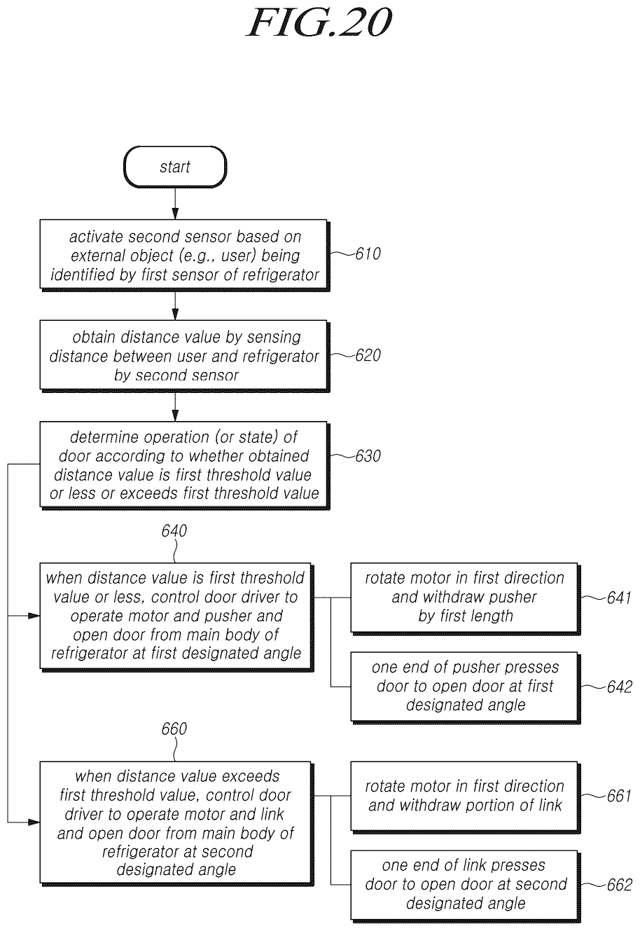

According to an embodiment, the configuration of the main body 10, the door 30, the door driver 400, the guide 200, and the lever device 100 of the refrigerator 1 of FIGS. 15 to 19 may be identical in whole or part to the configuration of the main body 10, the door 30, the door driver 400, the guide 200, and the lever device 100 of FIGS. 1 to 18. The embodiments of FIGS. 15 to 19 may be selectively combined with the embodiments of FIGS. 1 to 14, and the embodiments of FIGS. 20 to 25.

According to an embodiment, the door driver 400 may include at least one of a case 410, a motor 420, a pusher 430, a link 440, and gears 450.

According to an embodiment, the refrigerator 1 may include a door opening/closing guide module. The door opening/closing guide module may include a guide 200 and a lever device 100. According to an embodiment, the guide 200 may be provided to guide rotation of the door 30 when the door 30 is opened or closed. The guide 200 may be provided to lead the door 30 to rotate in a specific direction according to the position of the door 30. According to an embodiment, the lever device 100 may be mounted on the door 30. The lever device 100 may include a lever provided to contact the guide 200 when the door 30 is opened or closed.

According to an embodiment, the lever device 100 may be formed to guide the movement of the door 30 in contact with the guide 200 when the door 30 rotates to open or close the main body 10.

According to an embodiment, the refrigerator 1 of the disclosure may automatically open the door 30 that meets the user's intention by identifying an external object (e.g., the user) using a plurality of sensors and the door driver 400, detecting the distance between the user and the refrigerator 1, and opening at different opening angles of the door 30 with respect to the refrigerator 1.

According to an embodiment, the refrigerator 1 or the door 30 may include a first open operation and a second open operation, the first open operation may open the door 30 from the main body 10 by a first designated angle α, and the second open operation may open the door 30 from the main body 10 by a second designated angle γ larger than the first designated angle α.

Referring to FIGS. 15 and 16 according to an embodiment, the opening angle (e.g., the first designated angle α and/or the second designated angle γ) of the door 30 from the main body 10 may be determined by the curved angle β. For example, the opening angle of the door 30 from the main body 10 may be defined as “first designated angle α≤curve angle (β)≤second designated angle γ.” For example, the first designated angle α may be one of angles of 45 degrees or less. For example, the second designated angle γ may be one of angles larger than 45 degrees and smaller than or equal to 180 degrees.

According to an embodiment, the curve angle β may be defined as an angle of the virtual line G from the main body 10. The virtual line G may be a line connecting the curve point 213, which is one point of the guide 200, and the rotation shaft X of the door 30. The rotation shaft X of the door 30 may be a central axis about which the door 30 rotates from the main body 10. The curve point 213 may be one of the edges of the guide 200 for guiding the door 30 to open or close the main body 10. For example, the curve point 213 may be defined as a boundary point provided to apply a force in a direction in which the lever 130 of the lever device 100 opens or closes the door 30 according to the position of the lever device 100 with respect to the guide 200 when the door 30 is rotated to open or close the main body 10.

According to an embodiment, the refrigerator 1 may obtain a distance value between the refrigerator 1 and the user using the second sensor 720, and when the obtained distance value is smaller than or equal to the first threshold value, control the driving of the door driver 400 to open the door 30 at the first designated angle α. According to an embodiment, the first designated angle α may be smaller than or equal to the curve angle β. According to an embodiment, in the first open state of the door 30, the door 30 may form the first designated angle α from the main body 10.

According to an embodiment, in the first open operation of the door 30, the door driver 400 may move the pusher 430 from the first pusher position P1 toward the third pusher position P3, and may press to open the closed door 30. The pusher 430 may press the door 30 until it reaches the third pusher position P3. When the pusher 430 reaches the third pusher position P3, the door 30 may form the first designated angle α from the main body 10. According to an embodiment, the third pusher position P3 may be a portion of a length to which the pusher 430 may be exposed from the main body 10.

Hereinafter, referring to FIGS. 16 to 19, the direction in which the door 30 rotates, and the force applied to the door 30 by the operation of the lever device 100 with respect to the guide 200 (e.g., the curve point 213) are described in detail.

Referring to FIGS. 16 to 19, when the door 30 is opened or closed in the refrigerator 1 according to an embodiment of the disclosure, the door opening/closing guide module including the guide 200 and the lever device 100 may guide the rotation of the door 30. When the door 30 is opened or closed, the door opening/closing guide module including the guide 200 and the lever device 100 may provide a force to rotate the door 30 in the direction in which the door 30 is opened (i.e., in the first direction) or closed (i.e., in the second direction).

According to an embodiment, when the door 30 is opened, the lever 130 may move while in contact with the first contact surface 211 of the guide 200 and rotate with respect to the door 30. In this case, the spring 140 may be compressed to accumulate elastic force. For example, the spring 140 may be provided to be compressed by the lever 130 when the lever 130 contacts the first contact surface 211 and moves toward the curve point 213 along the first contact surface 211. When the door 30 is opened, the first contact surface 211 may be a section in which the lever device 100 accumulates elastic force. When the lever 130 (e.g., the roller 135 of the lever 130) passes through the first contact surface 211 and reaches the curve point 213, the elastic force accumulated in the lever 130 may be maximized.

According to an embodiment, if the opening angle of the door 30 further increases after the lever 130 contacts the curve point 213, the lever may contact the second contact surface 212, and the lever 130 may rotate in a direction in which the compressed spring 140 is restored. As the compressed spring 140 is restored, the elastic force accumulated in the spring 140 may be applied to the door 30 in a direction in which the opening angle of the door 30 further increases. For example, when the lever 130 moves away from the curve point 213 along the second contact surface 212 while in contact with the second contact surface 212, the spring 140 may apply an elastic force to the door 30 in a direction in which the opening angle increases. When the door 30 is opened, the second contact surface 212 may be a section in which the lever device 100 provides an elastic force to the door 30.

Referring to FIG. 16, when the door 30 is at the closed position, the lever 130 may contact the first contact surface 211 of the guide surface 210. Referring to FIG. 17, when the door 30 starts to rotate in the first direction from the closed position, the lever 130 may move along the first contact surface 211 and rotate about the lever shaft 113. If the lever 130 rotates about the lever shaft 113, the spring 140 may be compressed by the lever 130 and may accumulate elastic force. For example, when the lever 130 moves along the first contact surface 211 toward the curve point 213, the lever 130 may rotate clockwise about the lever shaft 113, thereby compressing the spring 140.

Referring to FIG. 17, when the opening angle of the door 30 is smaller than a reference angle a0 (see FIG. 18), the lever 130 may contact the first contact surface 211. The spring 140 may be compressed until the lever 130 moves along the first contact surface 211 and reaches the curve point 213.

Referring to FIG. 18, when the opening angle of the door 30 becomes the reference angle a0, the lever 130 may contact the curve point 213. When the lever 130 passes through the first contact surface 211 and reaches the curve point 213, the spring 140 may be compressed to the maximum.

According to an embodiment, when the lever 130 passes through the first contact surface 211 and reaches the curve point 213 and the spring 140 is compressed to the maximum, a repulsive force Fn of the guide 200 may be generated by the elastic force of the spring 140 in a direction perpendicular to the tangent C between the roller 135 of the lever 130 and the guide surface 210.

Then, referring to FIG. 19, when the opening angle of the door 30 exceeds the reference angle a0 (e.g., the first designated angle α), the lever 130 may move from the curve point 213 of the guide 200 toward the second contact surface 212 and may contact the second contact surface 212. When the lever 130 moves along the second contact surface 212 and moves away from the curve point 213, the spring 140 may extend from the maximally compressed length and be restored to the length before compression, and the lever 130 may move along the second contact surface 212 while rotating in the opposite direction. Referring to FIG. 17, when the lever 130 moves away from the curve point 213 along the second contact surface 212, the lever 130 may rotate counterclockwise about the lever shaft 113.

According to an embodiment, when the spring 140 is restored, the elastic force accumulated in the spring 140 may be applied to the door 30. When the roller 135 of the lever 130 contacts the second contact surface 212, the repulsive force Fn of the guide 200 by the elastic force of the spring 140 generated in the direction perpendicular to the tangent C between the roller 135 and the guide surface 210 may be applied to the door 30 in the direction in which the door 30 is opened (i.e., in the first direction). Therefore, if the lever 130 contacts the second contact surface 212 as the opening angle of the door 30 becomes larger than the reference angle a0, the door 30 may be opened by the elastic force transferred from the lever device 100.

Referring to FIGS. 18 and 19, the second contact surface 212 of the guide 200 may have a first point 212a, which is a point where the lever 130 enters in contact with the second contact surface 212 when the opening angle of the door 30 increases, and a second point 212b, which is a point where the lever 130 exits the second contact surface 212. In other words, when the opening angle of the door 30 increases, the lever 130 may pass through the first contact surface 211 and the curve point 213 and enter the second contact surface 212 through the first point 212a and, when reaching the second point 212b after moving along the second contact surface 212 from the first point 212a toward the second point 212b, exit the second contact surface 212.

According to an embodiment, when the opening angle of the door 30 is larger than the reference angle a0, the lever 130 may pass the first point 212a and reach the second contact surface 212. In this state, if the opening angle of the door 30 further increases, the lever 130 may pass through the second point 212b of the second contact surface 212 and may exit the second contact surface 212. Even after the lever 130 completely exits the second contact surface 212, as the elastic force is applied to the door 30 while the lever 130 moves along the second contact surface 212, the door 30 may continue to rotate toward the open position by inertia.

With such a structure, the door 30 may be automatically rotated in the first direction to be fully opened after being opened by an angle larger than the reference angle a0.

According to an embodiment, the closing of the door 30 may be performed by a reverse operation as illustrated in FIGS. 16 to 19. By such a door opening/closing guide module, the door 30 may be easily opened or closed, and the door 30 may be automatically opened or closed even when only a small force is applied to the door 30.

Further, the refrigerator 1 according to an embodiment of the disclosure may include a door opening/closing guide module including various components that guide the rotation of the door 30 by transferring a force to the door 30 when the door 30 rotates between the open position and the closed position.

FIG. 20 is a flowchart illustrating a door open operation with respect to a main body according to an embodiment of the disclosure.

According to an embodiment, the configuration of the main body 10, the door 30, and the door driver 400 of the refrigerator 1 of FIG. 20 may be identical in whole or part to the configuration of the main body 10, the door 30, and the door driver 400 of the refrigerator 1 of FIGS. 1 to 19. The embodiment of FIG. 20 may be selectively combined with the embodiments of FIGS. 1 to 19, and FIGS. 21 to 25.

According to an embodiment, the door driver 400 may include at least one of a case 410, a motor 420, a pusher 430, a link 440, and gears 450. (For example, see the case 410, motor 420, pusher 430, link 440, and gear 450 of FIGS. 10 to 13)

Referring to FIG. 20, the refrigerator 1 of the disclosure may automatically open the door 30 that meets the user's intention by identifying a user using a plurality of sensors and the door driver 400, detecting the distance between the user and the refrigerator 1, and opening the opening angle of the door 30 to the refrigerator 1 differently.

The following description of the embodiment of FIG. 20 focuses primarily on the differences from the embodiment of FIG. 6. Operation 610, operation 620, operation 630, operation 640 (operation 641 and operation 642) of FIG. 19 may be identical or similar to operation 610, operation 620, operation 630, and operation 640 (operation 641 and operation 642) of FIG. 6.

According to an embodiment, in operation 610, when the user approaches the refrigerator 1, the refrigerator 1 may identify the external object (e.g., the user) by the first sensor 710 and, based thereon, activate the second sensor 720. According to an embodiment, in the closed state of the door 30, at least one processor (e.g., the processor 191 of FIG. 3) of the refrigerator 1 may identify the user through the first sensor 710 and control the second sensor 720 to operate.

According to an embodiment, in operation 620, the refrigerator 1 may obtain a distance value by sensing a distance between an external object (e.g., the user) and the refrigerator 1 by the second sensor 720. According to an embodiment, in the closed state of the door 30, at least one processor 191 of the refrigerator 1 may obtain a distance value between the main body 10 and the user through the second sensor 720.

According to an embodiment, in operation 630, the refrigerator 1 may determine the operation (or state) of the door 30 separately for the case where the obtained distance value is the first threshold value or less and the case where the obtained distance value exceeds the first threshold value. According to an embodiment, in the closed state of the door 30, at least one processor 191 of the refrigerator 1 may control the door driver 400 to make the door 30 in different open states by distinguishing between when the distance value obtained by the second sensor 720 is smaller than or equal to the first threshold value and when the distance value exceeds the first threshold value.

According to an embodiment, in operation 640, when the distance value obtained using the second sensor 720 is smaller than or equal to the first threshold value, the refrigerator 1 may open the door 30 by controlling the door driver 400 (e.g., the pusher 430). Operation 640 may be defined as a first open operation and/or a first open state according to the first open operation of the door 30. The first open operation and the first open state may be understood as an operation and state for opening the door 30 from the main body 10 at an angle of about 45 degrees or less.

According to an embodiment, when the distance value obtained using the second sensor 720 is smaller than or equal to the first threshold value, the refrigerator 1 may perform the first open operation by driving the door driver 400. The door driver 400 may include a motor 420, a pusher 430 which provides a force to open the door 30, and a gear 450 for transferring power from the motor 420 to the pusher 430. The refrigerator 1 may rotate the motor 420 and transfer power to the pusher 430 through the gear 450 by the rotation of the motor 420. The pusher 430 may press the door 30 of the refrigerator 1 while moving in the front direction, and the door 30 may be opened by the first designated angle α.

According to an embodiment, in operation 641, the refrigerator 1 may rotate the motor 420 in the first direction (e.g., the forward rotation), and may withdraw a portion of the pusher 430 (e.g., the first length A1) from the main body 10. In operation 642, as the withdrawn one end of the pusher 430 presses the door 30, the door 30 may be opened from the main body 10.

In an embodiment, the pusher 430 and the gear engaged therewith may provide a rack-pinion gear structure. The rack (e.g., the moving rod 431) of the pusher 430 may include a rod gear part 431a, and the gear 450 that receives power from the motor 420 and engages with the rod gear part 431a may include a pinion gear 450. The rod gear part 431a and the pinion gear 450 may be engaged and rotated, and as the pinion gear 450 having a fixed position rotates in the first direction (e.g., the forward rotation), the pusher 430 may move in the front direction (e.g., the direction facing the door 30).

According to an embodiment, the pusher 430 may be exposed by the first length A1 from the main body 10 to open the door 30. For example, when the total length L where the pusher 430 may be exposed from the main body 10 is L, the pusher 430 may be withdrawn by a first length A1 which is a portion of L, pushing the door 30. The first length A1 may be understood as a gap between the main body 10 and the door 30 spaced apart by the pusher 430 as the door 30 has a first designated angle α from the main body 10.

According to an embodiment, in operation 660, when the distance value obtained using the second sensor 720 exceeds the first threshold value, the refrigerator 1 may open the door 30 by controlling the door driver 400 (e.g., the link 440). Operation 660 may be defined as a second open operation and/or a second open state according to the second open operation of the door 30. The second open operation and the second open state may be understood as an operation and state for opening the door 30 from the main body 10 at an angle larger than about 45 degrees and smaller than or equal to 180 degrees.

According to an embodiment, when the distance value obtained using the second sensor 720 exceeds the first threshold value, the refrigerator 1 may perform the second open operation by driving the door driver 400. The door driver 400 may include a motor 420, a link 440 which provides a force to open the door 30, and a gear 450 for transferring power from the motor 420 to the link 440. The refrigerator 1 may rotate the motor 420 and transfer power to the link 440 through the gear 450 by the rotation of the motor 420. The link 440 may press the door 30 of the refrigerator 1 while rotating and moving in the front direction, and the door 30 may be opened by the second designated angle γ.

According to an embodiment, in operation 661, the refrigerator 1 may rotate the motor 420 in the first direction (e.g., the forward rotation), and may withdraw a portion (e.g., the second link portion 442) of the link 440 from the main body 10. In operation 662, as the withdrawn one end of the link 440 presses the door 30, the door 30 may be opened from the main body 10.

According to an embodiment, the link 440 may include a first link portion 441 and a second link portion 442. The first link portion 441 may be rotatably connected to the main body 10, the second link portion 442 may be rotatably connected to the door 30, and the first link portion 441 and the second link portion 442 may be connected to be rotatable with respect to each other. In the second open operation, the first link portion 441 receiving power from the motor 420 rotates so that the portion connected to the second link portion 442 is positioned to face in the front direction, and the second link portion 442 is withdrawn from the case 410 and moves in the front direction while pressing the door 30 coupled to one end of the second link portion 442, opening the main body 10 into the second open state. The second open state may be an angle at which it is easy for the user to load or take out items in the storage compartment of the refrigerator 1.

According to an embodiment, the first link portion 441 of the link 440 may be rotated in conjunction with the gear (e.g., the link gear 451) engaged therewith. The gear 450 receiving the power from the motor 420 may include a link gear 451. For example, a plurality of gears may be disposed to be engaged with each other to rotate between the motor 420 and the link gear 451 and, as the position-fixed link gear 451, receiving power through the motor 420 and the plurality of gears 450, rotates in the first direction (e.g., the forward rotation), one end of the first link portion 441 may rotate in the front direction. The second link portion 442 connected to the first link portion 441 may partially rotate in the front direction and move, and may push the door 30 to open the door.

According to an embodiment of the disclosure, when the refrigerator 1 performs the first open operation (or the first open state), the pusher 430 of the door driver 400 may open the door 30 to form the first designated angle α (e.g., 45 degrees or less) from the main body 10. When the refrigerator 1 performs the second open operation (or the second open state), the link 440 of the door driver 400 may open the door 30 to form the second designated angle γ (e.g., 45 degrees or more and smaller than 180 degrees) from the main body 10.

For example, a case where the refrigerator 1 performs the second open operation using the link 440 of the door driver 400 is described. The door driver 400 may move one end of the second link portion 442 of the link 440 from the first link position L1 toward the second link position L2, and may further open the opened door 30. The link 440 may press the door 30 until the second link position L2 is reached. The link 440 may stop moving based on reaching the second link position L2. In this case, the link 440 may no longer press the door 30.

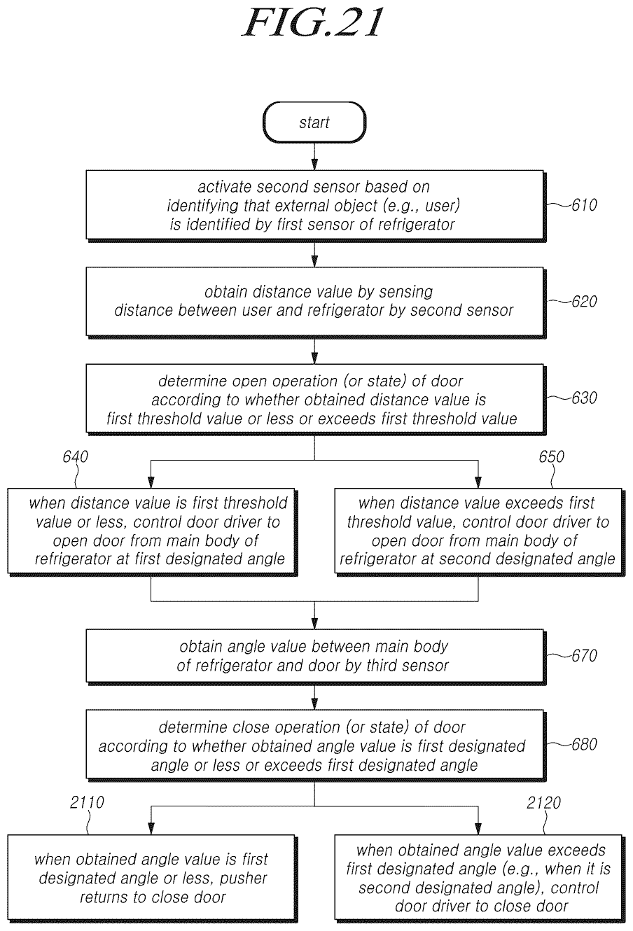

FIG. 21 is a flowchart illustrating an open operation and a close operation of a door from a main body according to an embodiment of the disclosure.

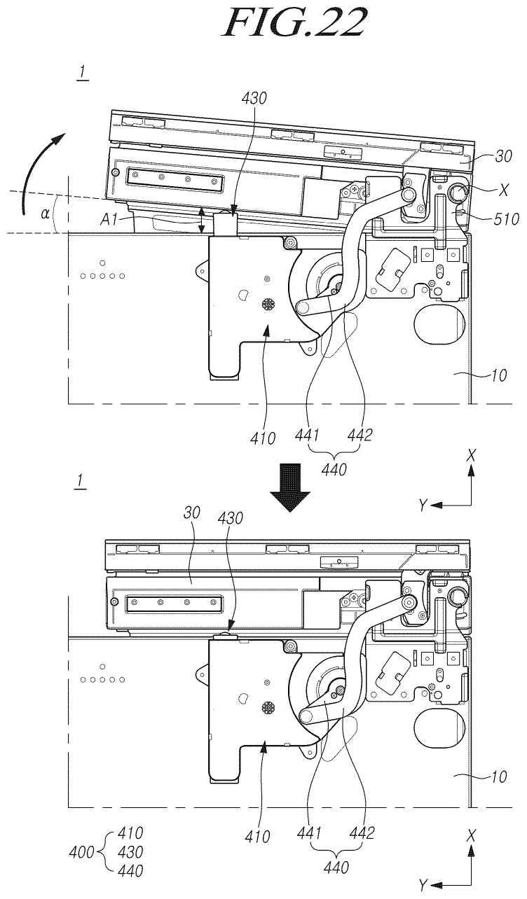

FIG. 22 is a view illustrating an operation of a refrigerator from a first open state to a closed state according to an embodiment of the disclosure.

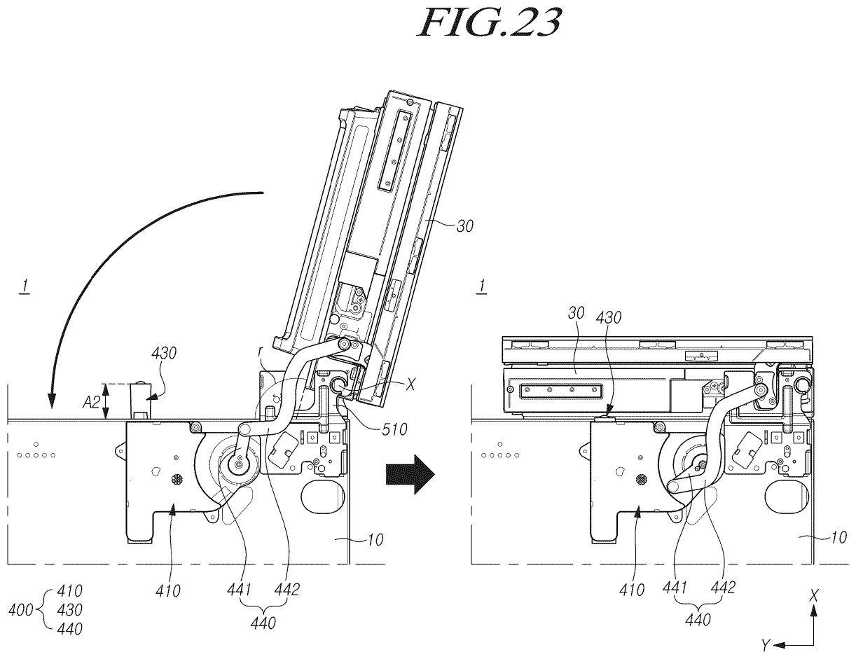

FIG. 23 is a view illustrating an operation of a refrigerator from a second open state to a closed state according to an embodiment of the disclosure.

According to an embodiment, the configuration of the main body 10, the door 30, and the door driver 400 of the refrigerator 1 of FIGS. 21 to 23 may be identical in whole or part to the configuration of the main body 10, the door 30, and the door driver 400 of the refrigerator 1 of FIGS. 1 to 20. The embodiments of FIGS. 21 to 23 may be selectively combined with the embodiments of FIGS. 1 to 20 and 25.

According to an embodiment, the door driver 400 may include at least one of a case 410, a motor 420, a pusher 430, a link 440, and gears 450.

According to an embodiment, the ‘close operation of the refrigerator 1 and/or the door 30’ may be divided into a ‘first close operation’ and a ‘second close operation’ according to the operation for closing the door 30 after being opened from the main body 10 (or the storage compartment 21). In the ‘first close operation’ and the ‘second close operation’, the close operation may be performed differently by other components in the door driver 400. The first close operation may be understood as an operation in which the door 30 is closed after being opened in a first designated angle α range (e.g., an angle range from 0 degrees to about 45 degrees or less). The second close operation may be understood as an operation in which the door 30 is closed after being opened from the main body 10 in a second designated angle γ range (e.g., an angle range of about 45 degrees to 180 degrees or less).

According to an embodiment, the ‘closed state of the refrigerator 1 and/or the door 30’ may be understood as a state in which the angle of the door 30 from the main body 10 is 0 degrees as the door 30 undergoes the close operation after being opened from the main body 10 (or the storage compartment 21).

Referring to FIGS. 21 to 23, the refrigerator 1 of the disclosure may automatically open the door 30 that meets the user's intention by identifying an external object (e.g., the user) using a plurality of sensors and the door driver 400, detecting the distance between the user and the refrigerator 1, and opening at different opening angles of the door 30 with respect to the refrigerator 1. The refrigerator 1 of the disclosure may automatically close the door 30 that meets the user's intention based on the door 30 being opened with respect to the refrigerator 1 at a different opening angle using at least one sensor and the door driver 400.

The following description of the embodiment of FIG. 20 focuses primarily on the differences from the embodiment of FIGS. 6 and 19. Operation 610, operation 620, operation 630, operation 640, and operation 650 of FIG. 20 may be identical or similar to operation 610, operation 620, operation 630, and operation 640, and operation 650 (or operation 660) of FIG. 6 (or FIG. 19).

According to an embodiment, in operation 610, when an external object (e.g., the user) approaches the refrigerator 1, the refrigerator 1 may identify the user by the first sensor 710 and, based thereon, activate the second sensor 720. According to an embodiment, in the closed state of the door 30, at least one processor (e.g., the processor 191 of FIG. 3) of the refrigerator 1 may identify the user through the first sensor 710 and control the second sensor 720 to operate.

According to an embodiment, in operation 620, the refrigerator 1 may obtain a distance value by sensing a distance between an external object (e.g., the user) and the refrigerator 1 by the second sensor 720. According to an embodiment, in the closed state of the door 30, at least one processor 191 of the refrigerator 1 may obtain a distance value between the main body 10 and the user through the second sensor 720.

According to an embodiment, in operation 630, the refrigerator 1 may determine the operation (or state) of the door 30 separately for the case where the obtained distance value is the first threshold value or less and the case where the obtained distance value exceeds the first threshold value. According to an embodiment, in the closed state of the door 30, at least one processor 191 of the refrigerator 1 may determine to control the door driver 400 by distinguishing between when the distance value obtained by the second sensor 720 is smaller than or equal to the first threshold value and when the distance value exceeds the first threshold value.

According to an embodiment, in operation 640, when the distance value obtained using the second sensor 720 is smaller than or equal to the first threshold value, the refrigerator 1 may open the door 30 by controlling the door driver 400 (e.g., the pusher 430). Operation 640 may be defined as a first open operation and/or a first open state according to the first open operation of the door 30. The first open operation and the first open state may be understood as an operation and state for opening the door 30 from the main body 10 at an angle of about 45 degrees or less.

According to an embodiment, when the distance value obtained using the second sensor 720 is smaller than or equal to the first threshold value, the refrigerator 1 may perform the first open operation by driving the door driver 400. The door driver 400 may include a motor 420, a pusher 430 which provides a force to open the door 30, and a gear 450 for transferring power from the motor 420 to the pusher 430. The refrigerator 1 may rotate the motor 420 and transfer power to the pusher 430 through the gear 450 by the rotation of the motor 420. The pusher 430 may press the door 30 of the refrigerator 1 while moving in the front direction, and the door 30 may be opened by the first designated angle α.

According to an embodiment, in operation 650, when the distance value obtained using the second sensor 720 exceeds the first threshold value, the refrigerator 1 may open the door 30 by controlling the door driver 400 (e.g., the pusher 430 and/or the link 440). Operation 650 may be defined as a second open operation and/or a second open state according to the second open operation of the door 30. The second open operation and the second open state may be understood as an operation and state for opening the door 30 from the main body 10 at an angle larger than about 45 degrees and smaller than or equal to 180 degrees.

According to an embodiment, when the distance value obtained using the second sensor 720 exceeds the first threshold value, the refrigerator 1 may perform the second open operation by driving the door driver 400. The door driver 400 may include a motor 420, a pusher 430 and a link 440 which provides a force to open the door 30, and a gear 450 for transferring power from the motor 420 to the link 440. The refrigerator 1 may rotate the motor 420 and transfer power to the pusher 430 and/or the link 440 through the gear 450 by the rotation of the motor 420.

According to an embodiment, the pusher 430 may press the door 30 of the refrigerator 1 while moving in the front direction, and the link 440 may press the door 30 of the refrigerator 1 while rotating and moving in the front direction, so that the door 30 may be opened at the second designated angle γ. For example, the second open operation may be performed as an operation in which the pusher 430 presses the door 30 to partially open the door 30 and then the link 440 additionally presses the door 30 to completely open the door 30. For example, the second open operation may be performed as an operation in which the pusher 430 and the link 440 together press the door 30 to completely open the door 30. For example, the second open operation may be performed as an operation in which only the link 440 presses the door 30 to completely open the door 30.

According to an embodiment, in operation 670, the refrigerator 1 may obtain an angle value by sensing an angle between the refrigerator 1 and the door 30 through the third sensor 730. According to an embodiment, in a state in which the door 30 is opened, at least one processor 191 of the refrigerator 1 may obtain an angle value of the door 30 from the main body 10 through the third sensor 730. According to an embodiment, the angle value may be an angle between one side (e.g., one side facing the door 30 in the closed state) of the main body 10 and one side (e.g., one side facing the main body 10 in the closed state) of the door 30 in the open operation or state.

According to an embodiment, the third sensor 730 may be an angle sensor. The angle sensor may detect the angle between the main body 10 and the door 30 and transfer a value determined according to a designated angle value to the processor 191. The angle sensor may detect the position of the door 30 by various methods. For example, the angle sensor may be provided to detect the magnetic field of a magnet mounted adjacent to the door driver 400. The angle sensor may detect a change in magnetic field by the magnet according to the movement of the door 30. For example, the angle sensor may include a hall sensor detecting the magnetic field. However, the type of the third sensor 730 is not limited thereto, and may include various types of sensors capable of detecting the angle of the door 30 from the main body 10. For example, it may include various types of sensors such as a reed switch or an optical sensor.

According to an embodiment, the third sensor 730 may be disposed inside the door driver 400 or adjacent to the door driver 400. For example, the third sensor 730 may be positioned in the case 410. For example, the third sensor 730 may be disposed adjacent to the link 440 or the link gear 451. However, the position of the third sensor 730 is not limited to that disclosed, and may be design-changed to a place where the angle between the main body 10 and the door 30 may be easily sensed.

According to an embodiment, in operation 680, the refrigerator 1 may determine the operation (or state) of the door 30 separately for the case where the obtained angle value is the first designated angle α or less and the case where the obtained angle value exceeds the first designated angle α. According to an embodiment, in the open state of the door 30, at least one processor 191 of the refrigerator 1 may determine to perform the close operation of the door 30 differently for the case where the obtained angle value is the first designated angle α or less and the case where the obtained angle value exceeds the first designated angle α.

According to an embodiment, the refrigerator 1 may determine to close the door 30 to the main body 10 when the angle value obtained using the third sensor 730 is smaller than or equal to the first designated angle. For example, the first designated angle α may be one of about 45 degrees or less. For example, the first designated angle α may be one of about 20 degrees or less.

According to an embodiment, the first designated angle α may be one of angles according to the first open operation of the door 30. The first designated angle α may be an angle in the first open state of the door 30.

According to an embodiment, the refrigerator 1 may determine to close the door 30 to the main body 10 when the angle value obtained using the third sensor 730 exceeds the first designated angle α. For example, exceeding the first designated angle α may be understood as the second designated angle γ. For example, the second designated angle γ may be one of more than about 45 degrees and 180 degrees or less. For example, the second designated angle γ may be one of smaller than about 120 degrees.

According to an embodiment, the second designated angle γ may be one of angles according to the second open operation of the door 30. The second designated angle γ may be an angle in the second open state of the door 30.

According to an embodiment, in operation 2110, if the angle value obtained using the third sensor 730 is the first designated angle α or less, the refrigerator 1 may close the door 30 by controlling the door driver 400. Operation 2110 may be defined as a first close operation and/or a closed state according to the first close operation of the door 30. The first close operation and the first closed state may be understood as an operation or state for the door 30 to become 0 degrees from the main body 10. Operation 2110 may be understood as a case in which no additional opening occurs after the first open state of the door 30.

According to an embodiment, when the angle value obtained using the third sensor 730 is the first designated angle α or less, the refrigerator 1 may perform the first close operation through driving of the door driver 400. The door driver 400 may include a motor 420, a pusher 430 and a link 440 which provide a force to open the door 30, and a gear 450 for transferring power from the motor 420 to the pusher 430 and/or the link 440.

According to an embodiment, in operation 2110a, the pusher 430 may move to be drawn into the receiving space 412 of the case 410 by itself. For example, the pusher 430 includes an elastic member (not shown) that provides elastic force in the rear direction, and if the transmission of power from the pusher 430 disappears, the elastic member may return the pusher 430 to its original position (e.g., within the receiving space 412 of the case 410 or to the first pusher position P1). In operation 2110a, as the pusher 430 having pressed the door 30 is drawn into the door driver 400, the door 30 may perform the first close operation and the first closed state by its own weight. The door 30 may rotate about the door rotation shaft X and close the main body 10.

According to an embodiment, in operation 2110b, the refrigerator 1 may rotate the motor 420 in the second rotation direction (e.g., the reverse rotation) to rotate the pinion gear 452 engaged with the pusher 430, and in conjunction therewith, return the pusher 430 to its original position (e.g., within the receiving space 412 of the case 410 or to the first pusher position P1). In operation 2110b, as the pusher 430 having pressed the door 30 is drawn by the operation of the door driver 400, the door 30 may perform the first close operation and the first closed state. The door 30 may rotate about the door rotation shaft X and close the main body 10.

Operation 2110a and operation 2110b may be performed individually or be selectively combined and performed. For example, in the first close operation and the first closed state, only operation 2110a or only operation 2110b may be performed.

According to an embodiment, in operation 2111, if the angle value obtained using the third sensor 730 is the first designated angle α or less, the refrigerator 1 may identify the user, and determine whether the user is identified to determine whether to perform the close operation. When the user is identified, the refrigerator 1 may maintain the first open state. When the user is not identified, the refrigerator 1 may perform the first close operation. For example, whether the user is identified may be performed through the first sensor 710,

According to an embodiment, in operation 2113, when the angle value obtained using the third sensor 730 is smaller than or equal to the first designated angle α, the refrigerator 1 may detect time and determine whether to perform the first close operation. After the first open state, when it is smaller than or equal to A seconds, the refrigerator 1 may maintain the first open state. After the first open state, when the time is more than A seconds, the refrigerator 1 may perform the first close operation. For example, A seconds may be one between about 5 and 15 seconds. For example, A seconds may be within about 10 seconds.

According to an embodiment, in operation 2115, when the angle value obtained using the third sensor 730 is smaller than or equal to the first designated angle α, the refrigerator 1 may determine whether to perform the first close operation by determining a distance between the main body 10 and the user U. When the distance between the main body 10 and the user is N or less, the refrigerator 1 may maintain the first open state. When the distance between the main body and the user is larger than N, the refrigerator 1 may perform the first close operation. For example, the distance N may correspond to the width of the door 30. For example, the distance N may be one of 0.8 to 1.2 m.

Operation 2111, operation 2113, and operation 2115 may be performed individually or be selectively combined and performed.

According to an embodiment, in operation 2120, when the angle value obtained using the third sensor 730 exceeds the first designated angle α, the refrigerator 1 may control the door driver 400 to close the door 30. Operation 2120 may be defined as a second close operation and/or a closed state according to the second close operation of the door 30. The second close operation and closed state may be understood as an operation or state for the door 30 to become 0 degrees from the main body 10. Operation 2120 may be understood as an operation after the first open state of the door 30, when there is an additional open state, or an operation after the second open state. For example, when there is additional opening may be understood as a state in which, after the first open state of the door 30, the user U additionally opens the door 30 so that the door is opened to exceed the first designated angle α.

According to an embodiment, when the angle value obtained using the third sensor 730 exceeds the first designated angle α (e.g., when it is the second designated angle γ), the refrigerator 1 may perform the second close operation by driving the door driver 400. The door driver 400 may include a motor 420, a pusher 430 and a link 440 which provide a force to open the door 30, and a gear 450 for transferring power from the motor 420 to the pusher 430 and/or the link 440.

According to an embodiment, in operation 2120a, the refrigerator 1 may rotate the motor 420 in the second rotation direction (e.g., the reverse rotation) to rotate the link gear 451 engaged with the link 440, and in conjunction therewith, return the link 440 to its original position (e.g., within the receiving space 412 of the case 410 or to the first link position L1). In operation 2120a, as the link 440 having pressed the door 30 is drawn by the operation of the door driver 400, the door 30 may be pulled and perform the first close operation and the first closed state. The door 30 may rotate about the door rotation shaft X and close the main body 10.

According to an embodiment, in operation 2121, if the angle value obtained using the third sensor 730 exceeds the first designated angle α (e.g., when it is the second designated angle γ), the refrigerator 1 may identify the user, and determine whether the user is identified to determine whether to perform the second close operation. When the user is identified, the refrigerator 1 may maintain the second open state. When the user is not identified, the refrigerator 1 may perform the second close operation. For example, whether the user is identified may be performed through the first sensor 710,

According to an embodiment, in operation 2113, if the angle value obtained using the third sensor 730 exceeds the first designated angle α (e.g., when it is the second designated angle γ), the refrigerator 1 may detect time to determine whether to perform the second close operation. After the second open state, when it is smaller than or equal to B seconds, the refrigerator 1 may maintain the second open state. After the second open state, when the time is more than B seconds, the refrigerator 1 may perform the second close operation. For example, B seconds may be one between about 5 and 15 seconds. For example, B seconds may be within about 10 seconds. For example, B seconds may be A seconds or more.

According to an embodiment, in operation 2115, if the angle value obtained using the third sensor 730 exceeds the first designated angle α (e.g., when it is the second designated angle γ), the refrigerator 1 may determine the distance between the main body 10 and the user U to determine whether to perform the second close operation. When the distance between the main body 10 and the user is M or less, the refrigerator 1 may maintain the second open state. When the distance between the main body 10 and the user M is larger than N, the refrigerator 1 may perform the second close operation. For example, the distance M may correspond to the width of the door 30. For example, the distance M may be one of 0.8 to 1.2 m. For example, the distance M may be larger than or equal to the distance N.

Operation 2111, operation 2113, and operation 2115 may be performed individually or be selectively combined and performed.

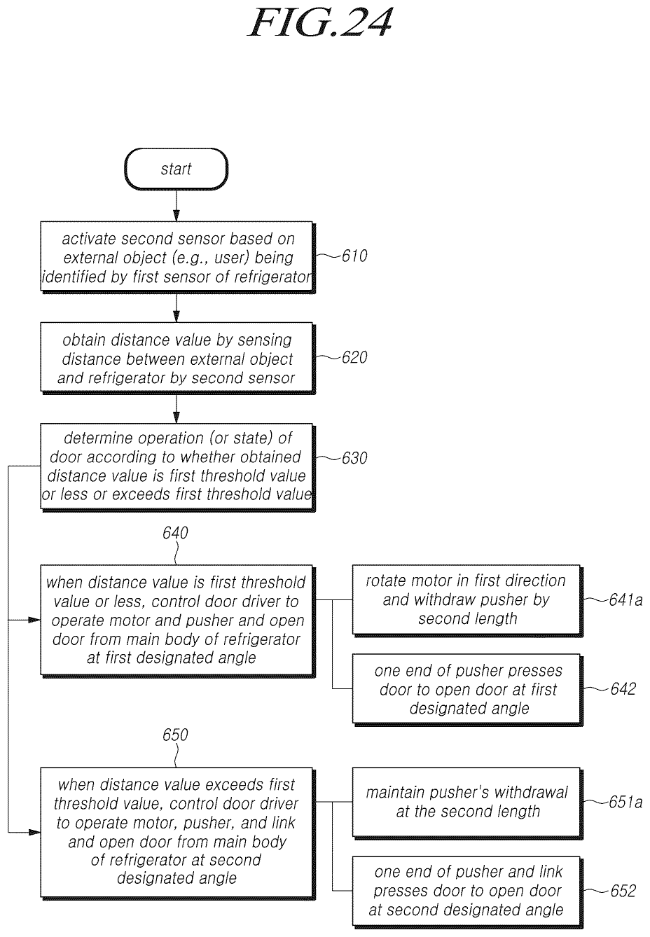

FIG. 24 is a flowchart illustrating an open operation of a door from a main body according to an embodiment of the disclosure.

According to an embodiment, the configuration of the main body 10, the door 30, and the door driver 400 of the refrigerator 1 of FIG. 24 may be identical in whole or part to the configuration of the main body 10, the door 30, and the door driver 400 of the refrigerator 1 of FIGS. 1 to 23. The embodiment of FIG. 24 may be selectively combined with the embodiments of FIGS. 1 to 23 and 25.

According to an embodiment, the door driver 400 may include at least one of a case 410, a motor 420, a pusher 430, a link 440, and gears 450 (for example, see the case 410, the motor 420, the pusher 430, the link 440, and the gears 450 of FIGS. 10 to 13).

Referring to FIG. 24, the refrigerator 1 of the disclosure may automatically open the door 30 that meets the user's intention by identifying a user using a plurality of sensors and the door driver 400, detecting the distance between the user and the refrigerator 1, and opening the opening angle of the door 30 to the refrigerator 1 differently.

The following description of the embodiment of FIG. 24 focuses primarily on the differences from the embodiment of FIG. 6. Operation 610, operation 620, operation 630, operation 640 (operation 641 and operation 642) of FIG. 19 may be identical or similar to operation 610, operation 620, operation 630, and operation 640 (operation 641 and operation 642) of FIG. 6.

According to an embodiment, in operation 610, when the user approaches the refrigerator 1, the refrigerator 1 may identify the external object (e.g., the user) by the first sensor 710 and, based thereon, activate the second sensor 720. According to an embodiment, in the closed state of the door 30, at least one processor (e.g., the processor 191 of FIG. 3) of the refrigerator 1 may identify the user through the first sensor 710 and control the second sensor 720 to operate.

According to an embodiment, in operation 620, the refrigerator 1 may obtain a distance value by sensing a distance between an external object (e.g., the user) and the refrigerator 1 by the second sensor 720. According to an embodiment, in the closed state of the door 30, at least one processor 191 of the refrigerator 1 may obtain a distance value between the main body 10 and the user through the second sensor 720.

According to an embodiment, in operation 630, the refrigerator 1 may determine the operation (or state) of the door 30 separately for the case where the obtained distance value is the first threshold value or less and the case where the obtained distance value exceeds the first threshold value. According to an embodiment, in the closed state of the door 30, at least one processor 191 of the refrigerator 1 may control the door driver 400 to make the door 30 in different open states by distinguishing between when the distance value obtained by the second sensor 720 is smaller than or equal to the first threshold value and when the distance value exceeds the first threshold value.

According to an embodiment, in operation 640, when the distance value obtained using the second sensor 720 is smaller than or equal to the first threshold value, the refrigerator 1 may open the door 30 by controlling the door driver 400 (e.g., the pusher 430). Operation 640 may be defined as a first open operation and/or a first open state according to the first open operation of the door 30. The first open operation and the first open state may be understood as an operation and state for opening the door 30 from the main body 10 at an angle of about 45 degrees or less.

According to an embodiment, when the distance value obtained using the second sensor 720 is smaller than or equal to the first threshold value, the refrigerator 1 may perform the first open operation by driving the door driver 400. The door driver 400 may include a motor 420, a pusher 430 which provides a force to open the door 30, and a gear 450 for transferring power from the motor 420 to the pusher 430. The refrigerator 1 may rotate the motor 420 and transfer power to the pusher 430 through the gear 450 by the rotation of the motor 420. The pusher 430 may press the door 30 of the refrigerator 1 while moving in the front direction, and the door 30 may be opened by the first designated angle α.

According to an embodiment, in operation 641a, the refrigerator 1 may rotate the motor 420 in the first direction (e.g., the forward rotation), and may withdraw the pusher 430 from the main body 10. In operation 642, as the withdrawn one end of the pusher 430 presses the door 30, the door 30 may be opened from the main body 10.

In an embodiment, the pusher 430 and the gear engaged therewith may provide a rack-pinion gear structure. The rack (e.g., the moving rod 431) of the pusher 430 may include a rod gear part 431a, and the gear 450 that receives power from the motor 420 and engages with the rod gear part 431a may include a pinion gear 450. The rod gear part 431a and the pinion gear 450 may be engaged and rotated, and as the pinion gear 450 having a fixed position rotates in the first direction (e.g., the forward rotation), the pusher 430 may move in the front direction (e.g., the direction facing the door 30).

According to an embodiment, in the first open operation (e.g., in operation 641a and in operation 642), the pusher 430 may be exposed by the second length A2 from the main body 10 to open the door 30. For example, when the total length L in which the pusher 430 may be exposed from the main body 10, L and the second length A2 may be the same, the pusher 430 may be withdrawn by the second length A2 to push the door 30 and, as the door 30 forms the first designated angle α from the main body 10, the second length A2 may be understood as a gap between the door 30 and the main body 10 spaced apart by the pusher 430.

According to an embodiment, in operation 650, when the distance value obtained using the second sensor 720 exceeds the first threshold value, the refrigerator 1 may open the door 30 by controlling the door driver 400 (e.g., the pusher 430 and the link 440). Operation 650 may be defined as a second open operation and/or a second open state according to the second open operation of the door 30. The second open operation and the second open state may be understood as an operation and state for opening the door 30 from the main body 10 at an angle larger than about 45 degrees and smaller than or equal to 180 degrees.

According to an embodiment, when the distance value obtained using the second sensor 720 exceeds the first threshold value, the refrigerator 1 may perform the second open operation by driving the door driver 400. The door driver 400 may include a motor 420, a pusher 430 and a link 440 which provide a force to open the door 30, and a gear 450 for transferring power from the motor 420 to the pusher 430 and the link 440.

According to an embodiment, in operation 651a, the refrigerator 1 may rotate the motor 420 in the first direction (e.g., the forward rotation), and maintain a state in which a portion (e.g., a second length A2) of the pusher 430 is withdrawn from the main body 10.

According to an embodiment, in operation 652, as one end of the withdrawn pusher 430 and one end of the link 440 (e.g., the second link part 442) press the door 30, the door 30 may be opened from the main body 10.

According to an embodiment, the second open operation may use the pusher 430 and/or the link 440 to open the door 30. The refrigerator 1 may rotate the motor and transfer power to the link 440 through the gear 450 by the rotation of the motor. The link 440 may press the door 30 to further extend the opening range of the door 30 from the main body 10. The link 440 may further open the door 30 opened by the pusher 430 from the main body 10.

According to an embodiment, in the second open operation, the pusher 430 may be exposed by the second length A2 from the main body 10 to open the door 30. For example, when the total length L in which the pusher 430 may be exposed from the main body 10, L and the second length A2 may be the same, the pusher 430 may be withdrawn by the second length A2 to push the door 30 and, as the door 30 forms the second designated angle γ from the main body 10, the second length A2 may be understood as a gap between the door 30 and the main body 10 spaced apart by the pusher 430. The withdrawn lengths of the pusher 430 in the first open state and the second open state may be the same.

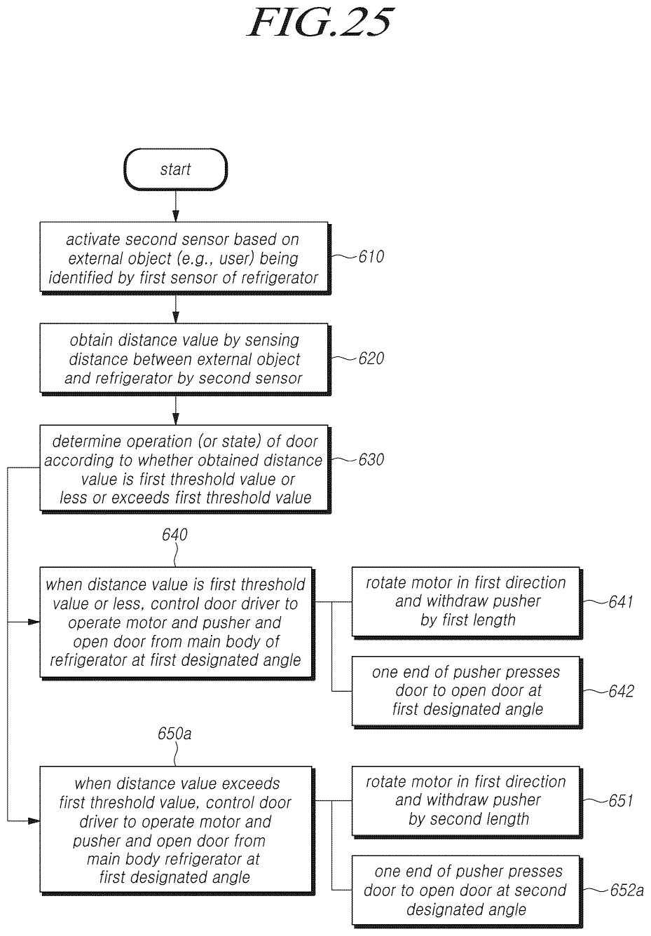

FIG. 25 is a flowchart illustrating an open operation of a door from a main body according to an embodiment of the disclosure.

According to an embodiment, the configuration of the main body 10, the door 30, and the door driver 400 of the refrigerator 1 of FIG. 25 may be identical in whole or part to the configuration of the main body 10, the door 30, and the door driver 400 of the refrigerator 1 of FIGS. 1 to 24. The embodiment of FIG. 25 may be selectively combined with the embodiments of FIGS. 1 to 24.

According to an embodiment, the door driver 400 may include at least one of a case 410, a motor 420, a pusher 430, a link 440, and gears 450 (for example, see the case 410, the motor 420, the pusher 430, the link 440, and the gears 450 of FIGS. 10 to 13).

Referring to FIG. 25, the refrigerator 1 of the disclosure may automatically open the door 30 that meets the user's intention by identifying a user using a plurality of sensors and the door driver 400, detecting the distance between the user and the refrigerator 1, and opening the opening angle of the door 30 to the refrigerator 1 differently.

The following description of the embodiment of FIG. 25 focuses primarily on the differences from the embodiment of FIG. 6. Operation 610, operation 620, operation 630, operation 640 (operation 641 and operation 642) of FIG. 19 may be identical or similar to operation 610, operation 620, operation 630, and operation 640 (operation 641 and operation 642) of FIG. 6.

According to an embodiment, in operation 610, when the user approaches the refrigerator 1, the refrigerator 1 may identify the external object (e.g., the user) by the first sensor 710 and, based thereon, activate the second sensor 720. According to an embodiment, in the closed state of the door 30, at least one processor (e.g., the processor 191 of FIG. 3) of the refrigerator 1 may identify the user through the first sensor 710 and control the second sensor 720 to operate.

According to an embodiment, in operation 620, the refrigerator 1 may obtain a distance value by sensing a distance between an external object (e.g., the user) and the refrigerator 1 by the second sensor 720. According to an embodiment, in the closed state of the door 30, at least one processor 191 of the refrigerator 1 may obtain a distance value between the main body 10 and the user through the second sensor 720.

According to an embodiment, in operation 630, the refrigerator 1 may determine the operation (or state) of the door 30 separately for the case where the obtained distance value is the first threshold value or less and the case where the obtained distance value exceeds the first threshold value. According to an embodiment, in the closed state of the door 30, at least one processor 191 of the refrigerator 1 may control the door driver 400 to make the door 30 in different open states by distinguishing between when the distance value obtained by the second sensor 720 is smaller than or equal to the first threshold value and when the distance value exceeds the first threshold value.

According to an embodiment, in operation 640, when the distance value obtained using the second sensor 720 is smaller than or equal to the first threshold value, the refrigerator 1 may open the door 30 by controlling the door driver 400 (e.g., the pusher 430). Operation 640 may be defined as a first open operation and/or a first open state according to the first open operation of the door 30. The first open operation and the first open state may be understood as an operation and state for opening the door 30 from the main body 10 at an angle of about 45 degrees or less.

According to an embodiment, when the distance value obtained using the second sensor 720 is smaller than or equal to the first threshold value, the refrigerator 1 may perform the first open operation by driving the door driver 400. The door driver 400 may include a motor 420, a pusher 430 which provides a force to open the door 30, and a gear 450 for transferring power from the motor 420 to the pusher 430. The refrigerator 1 may rotate the motor 420 and transfer power to the pusher 430 through the gear 450 by the rotation of the motor 420. The pusher 430 may press the door 30 of the refrigerator 1 while moving in the front direction, and the door 30 may be opened by the first designated angle α.

According to an embodiment, in operation 641, the refrigerator 1 may rotate the motor 420 in the first direction (e.g., the forward rotation), and may withdraw a portion of the pusher 430 (e.g., the first length A1) from the main body 10. In operation 642, as the withdrawn one end of the pusher 430 presses the door 30, the door 30 may be opened from the main body 10.

In an embodiment, the pusher 430 and the gear engaged therewith may provide a rack-pinion gear structure. The rack (e.g., the moving rod 431) of the pusher 430 may include a rod gear part 431a, and the gear 450 that receives power from the motor 420 and engages with the rod gear part 431a may include a pinion gear 450. The rod gear part 431a and the pinion gear 450 may be engaged and rotated, and as the pinion gear 450 having a fixed position rotates in the first direction (e.g., the forward rotation), the pusher 430 may move in the front direction (e.g., the direction facing the door 30).

According to an embodiment, in the first open operation, the pusher 430 may be exposed by the first length A1 from the main body 10 to open the door 30. For example, when the total length L where the pusher 430 may be exposed from the main body 10 is L, the pusher 430 may be withdrawn by a first length A1 which is a portion of L, pushing the door 30. The first length A1 may be understood as a distance gap between the main body 10 and the door 30 spaced apart by the pusher 430 as the door 30 has a first designated angle α from the main body 10.

According to an embodiment, in operation 650a, when the distance value obtained using the second sensor 720 exceeds the first threshold value, the refrigerator 1 may open the door 30 by controlling the door driver 400 (e.g., the pusher 430). Operation 650a may be defined as a second open operation and/or a second open state according to the second open operation of the door 30. The second open operation and the second open state may be understood as an operation and state for opening the door 30 from the main body 10 at an angle larger than about 45 degrees and smaller than or equal to 180 degrees.

According to an embodiment, when the distance value obtained using the second sensor 720 exceeds the first threshold value, the refrigerator 1 may perform the second open operation by driving the door driver 400. The door driver 400 may include a motor 420, a pusher 430 and a link 440 which provide a force to open the door 30, and a gear 450 for transferring power from the motor 420 to the pusher 430 and the link 440.

According to an embodiment, in operation 651, the refrigerator 1 may rotate the motor 420 in the first direction (e.g., the forward rotation), and may withdraw a portion (e.g., a second length A2) of the pusher 430 from the main body 10. The refrigerator 1 may rotate the motor 420 in the first direction (e.g., the forward rotation), and may withdraw a portion of the link 440 from the main body 10.

According to an embodiment, in operation 652a, as the withdrawn one end of the pusher 430 presses the door 30, the door 30 may be opened from the main body 10.

According to an embodiment, the second open operation may use only the pusher 430 to open the door 30. For example, the refrigerator 1 may rotate the motor and transfer power to the pusher 430 through the gear 450 by the rotation of the motor. The pusher 430 may press the door 30 of the refrigerator 1 while moving in the front direction (e.g., the X-axis direction), and the door 30 may be opened.

According to an embodiment, in the second open operation, the pusher 430 may be exposed by the second length A2 from the main body 10 to open the door 30. For example, when the total length L in which the pusher 430 may be exposed from the main body 10, L and the second length A2 may be the same, the pusher 430 may be withdrawn by the second length A2 to push the door 30 and, as the door 30 forms the second designated angle γ from the main body 10, the second length A2 may be understood as a gap between the door 30 and the main body 10 spaced apart by the pusher 430.

Conventional automatic refrigerator door opening techniques are limited to partially or fully opening the door.

A refrigerator according to an embodiment of the disclosure may provide an enhanced structure capable of automatically opening the door.

A refrigerator according to an embodiment of the disclosure may provide an enhanced structure capable of easily opening or closing the door.

A refrigerator according to an embodiment of the disclosure may automatically open the door at various angles from the main body (or storage compartment) based on the distance from the user.

A refrigerator according to an embodiment of the disclosure may automatically open the door and perform a first open operation and a second open operation separately depending on the door opening angle. The first open operation may open the door by the pusher of the door driver, and the second open operation may open the door by the pusher and/or the link of the door driver.

A refrigerator according to an embodiment of the disclosure may provide various door closing methods based on the angle of the door from the main body (or storage compartment) in the open state of the refrigerator.

A refrigerator according to an embodiment of the disclosure may provide various door closing methods based on whether the user is identified in the open state of the refrigerator.

A refrigerator according to an embodiment of the disclosure may provide various types of door closing based on the distance from the user in the open state of the refrigerator.

A refrigerator according to an embodiment of the disclosure may provide various types of door closing based on the time when the door is open in the open state of the refrigerator.

Effects obtainable from the disclosure are not limited to the above-mentioned effects, and other effects not mentioned may be apparent to one of ordinary skill in the art from the following description.

A refrigerator 1 according to an embodiment of the disclosure may comprise a main body 10, a door 30 rotatably connected to open or close the main body, a door driver 400 configured to automatically rotate the door from the main body, a sensor disposed at one side of the main body or the door to face in a front direction, and at least one processor 191. In a closed state of the door, the at least one processor may determine whether a sensing data value obtained by the sensor is a first threshold value or less. The at least one processor may control the door driver to open the door from the main body at a first designated angle α based on determining that the sensing data value is the first threshold value or less. The at least one processor may control the door driver to open the door from the main body at a second designated angle γ larger than the first designated angle α based on determining that the sensing data value exceeds the first threshold value.

According to an embodiment, the refrigerator may further comprise a lever device 100 disposed on the door to facilitate movement of the door and a guide 200 provided to guide movement of the lever device 100 while being contacted by the lever device 100 when the door rotates to open or close the main body.

According to an embodiment, the guide may include a curve point 213 which is a boundary point provided to apply a force in a direction in which the door opens or closes the main body among movement points of the lever device 100. The curve angle β may be defined as an angle of an imaginary line connecting the curve point and a rotation shaft of the door from the main body.

According to an embodiment, the first designated angle α may have a value smaller than or equal to the curve angle β.

According to an embodiment, the second designated angle γ may have a value exceeding the curve angle.

According to an embodiment, the sensor may include a first sensor 710 disposed on one side of the main body or the door to face in the front direction to identify an external object and a second sensor 720 disposed on one side of the door to face in the front direction to sense a distance based on identifying the external object by the first sensor.

According to an embodiment, the sensing data value may include a distance value between the main body and the external object through the second sensor.

According to an embodiment, the refrigerator may further comprise a third sensor 730 disposed adjacent to the door driver to sense an angle of the door from the main body.

According to an embodiment, in an open state of the door, the at least one processor may obtain an angle value between the main body and the door through the third sensor, and upon determining that the obtained angle value exceeds the first designated angle α and the distance value obtained by the second sensor 720 exceeds a second threshold value, control the door driver to close the door from the main body.

According to an embodiment, in an open state of the door, the at least one processor may obtain an angle value between the main body and the door through the third sensor, and upon determining that the obtained angle value exceeds the first designated angle α and after a designated time, control the door driver to close the door from the main body.

According to an embodiment, the first designated angle α may be one of 45 degrees or less, and the second designated angle γ may be one of larger than 45 degrees, and smaller than or equal to 180 degrees.

According to an embodiment, the door driver may include a motor 420, a pusher 430 configured to push to open the door from the main body, a link 440 disposed to connect the main body and the door and including a first link portion and a second link portion rotatably connected to one end of the first link portion, and a plurality of gears 450 for transferring a driving force of the motor to the pusher and/or the link.

According to an embodiment, to open the door at the first designated angle α, the at least one processor may withdraw the pusher from the main body through the door driver and control the pusher to push the door and the door to open while rotating about a door rotation shaft according to the withdrawing operation.

According to an embodiment, to open the door at the second designated angle γ, the at least one processor may withdraw and rotate a portion of the pusher and/or the link from the main body through the door driver and controls the link to apply a force to the door and the door to open while rotating about a door rotation shaft of the door according to the varying operation.

According to an embodiment, after the door is opened at the first designated angle α, when the door is opened at the first designated angle α by the external object, the at least one processor may control the door driver to rotate the door to close the main body based on the first sensor failing to identify the external object.

According to an embodiment, after opening the door from the main body at the second designated angle γ, the at least one processor may control the door driver to rotate the door to close the main body based on the first sensor failing to identify the external object.

According to an embodiment, after the door is opened at the first designated angle α, a portion of the pusher, withdrawn from the main body, may return to an inside of the main body, and the door may close the main body by its own weight.

According to an embodiment, after the door is opened at the first designated angle α, when the door is opened at the first designated angle α by the external object, the at least one processor may control the door driver to rotate the door to close the main body after a first designated time in a state opened at the first designated angle α.

According to an embodiment, after the door is opened in a range of the second designated angle γ, the at least one processor may control the door driver to rotate the door to close the main body after a second designated time in a state opened at the second designated angle γ.

According to an embodiment, the pusher may be configured to be movable between a first pusher position which is a position of the pusher when the main body is closed and a second pusher position moved from the first pusher position in a direction pressing the door. When the door is at the first designated angle α from the main body, the pusher may be positioned between the first pusher position and the second pusher position. When the door is at the second designated angle γ from the main body, the pusher may be positioned at the second pusher position.

According to an embodiment, the pusher may be configured to be movable between a first pusher position which is a position of the pusher when the main body is closed and a second pusher position moved from the first pusher position in a direction pressing the door. When the door is at the first designated angle α from the main body, the pusher may be positioned at the second pusher position. When the door is at the second designated angle γ from the main body, the pusher may be positioned at the first pusher position.

According to an embodiment, the link may include a first link portion 441 rotatably connected to the main body and a second link portion 442 rotatably connected to the door. The link may be configured to be movable between a first link position which is a position of one end of the second link portion when the main body is closed and a second link position moved from the first link position in a direction pressing the door. When the door is at the first designated angle α from the main body, the link may be positioned at the first link position, and when the door is at the second designated angle γ from the main body, the link may be positioned at the second link position.

A refrigerator 1 according to an embodiment of the disclosure may comprise a main body 10, a door 30 rotatably connected to open or close the main body, a door driver 400 configured to automatically rotate the door from the main body, a lever device 100 disposed on the door to facilitate movement of the door, a guide 200 provided to guide movement of the lever device while being contacted by the lever device when the door rotates to open or close the main body, a first sensor 710 disposed on one side of the main body or the door to face in the front direction to identify an external object, a second sensor 720 disposed on one side of the door to face in the front direction to sense a distance based on identifying the external object by the first sensor, and at least one processor. In a closed state of the door, the at least one processor may obtain a distance value between the main body and the external object through the second sensor and, upon determining that the obtained distance value is a first threshold value or less, control the door driver to open the door at a first designated angle α from the main body. The guide may include a curve point 213 which is a boundary point provided to apply a force in a direction in which the door opens or closes the main body among movement points of the lever device. The curve angle β may be defined as an angle of an imaginary line connecting the curve point and a rotation shaft X of the door from the main body, and the first designated angle α may have a value smaller than or equal to the curve angle.

According to an embodiment, in a closed state of the door, the at least one processor may control the door driver to open the door from the main body at a second designated angle γ larger than the first designated angle α upon determining that the obtained distance value exceeds the first threshold value.

According to an embodiment, the first designated angle α may be one of 45 degrees or less, and the second designated angle γ may be one of larger than 45 degrees, and smaller than or equal to 180 degrees.

According to an embodiment, the refrigerator may further comprise a third sensor disposed adjacent to the door driver to sense an angle of the door from the main body. In an open state of the door, the at least one processor may obtain an angle value between the main body and the door through the third sensor, and upon determining that the obtained angle value exceeds the first designated angle α and the distance value obtained by the second sensor 720 exceeds a second threshold value, control the door driver to close the door from the main body.

A refrigerator 1 according to an embodiment of the disclosure may comprise a main body 10, a door 30 rotatably connected to open or close the main body, a door driver 400 configured to automatically rotate the door from the main body, a first sensor 710 disposed on one side of the main body or the door to face in the front direction to identify an external object, a second sensor 720 disposed on one side of the door to face in the front direction to sense a distance based on identifying the external object by the first sensor, and at least one processor 191. In a closed state of the door, the at least one processor may obtain a distance value between the main body and the external object through the second sensor, upon determining that the obtained distance value is a first threshold value or less, control the door driver to open the door at a first designated angle α from the main body and, upon determining that the obtained distance value exceeds the first threshold value, control the door driver to open the door from the main body at a second designated angle γ larger than the first designated angle α

A refrigerator 1 according to an embodiment of the disclosure may comprise a main body 10, a door 30 rotatably connected to open or close the main body, a door driver 400 configured to automatically rotate the door from the main body, a sensor disposed at one side of the main body or the door to face in a front direction, memory storing one or more computer programs, and one or more processors 191 communicatively coupled to the door driver, the sensor, and the memory. the one or more computer programs may include computer-executable instructions that, when executed by the one or more processors individually or collectively, cause the refrigerator in a closed state of the door to, determine whether a sensing data value obtained by the sensor is a first threshold value or less, control the door driver to open the door from the main body at a first designated angle α based on determining that the sensing data value is the first threshold value or less, and control the door driver to open the door from the main body at a second designated angle γ larger than the first designated angle α based on determining that the sensing data value exceeds the first threshold value.

According to an embodiment, the sensor may include a first sensor 710 disposed on one side of the main body or the door to face in the front direction to identify an external object and a second sensor 720 disposed on one side of the door to face in the front direction to sense a distance based on identifying the external object by the first sensor.

According to an embodiment, the sensor may further include a third sensor disposed adjacent to the door driver to sense an angle of the door relative to the main body. The one or more computer programs may further include computer-executable instructions that, when executed by the one or more processors individually or collectively, cause the refrigerator in an open state of the door to, obtain an angle value between the main body and the door through the third sensor, and upon determining that the obtained angle value exceeds the first designated angle α and the distance value obtained by the second sensor exceeds a second threshold value, control the door driver to close the door relative to the main body.

According to an embodiment, the sensor may further include a third sensor disposed adjacent to the door driver to sense an angle of the door relative to the main body. The one or more computer programs further include computer-executable instructions that, when executed by the one or more processors individually or collectively, cause the refrigerator in an open state of the door to, obtain an angle value between the main body and the door through the third sensor, and upon determining that the obtained angle value exceeds the first designated angle α and after a designated time, control the door driver to close the door relative to the main body.

According to an embodiment, to open the door at the first designated angle α, the one or more computer programs may further include computer-executable instructions that, when executed by the one or more processors individually or collectively, cause the refrigerator to control the door driver to: withdraw the pusher from the main body, and control the pusher to push the door and the door to open while rotating about a door rotation shaft according to the withdrawing of the pusher from the main body.

According to an embodiment, to open the door at the second designated angle γ, the one or more computer programs may further include computer-executable instructions that, when executed by the one or more processors individually or collectively, cause the refrigerator to control the door driver to, withdraw and rotate a portion of the pusher and/or the link from the main body through the door driver, and control the link to apply a force to the door and the door to open while rotating about a door rotation shaft of the door.

According to an embodiment, after the door is opened at the first designated angle, when the door is opened at the first designated angle by the external object, the one or more computer programs may further include computer-executable instructions that, when executed by the one or more processors individually or collectively, cause the refrigerator to control the door driver to control the door driver to rotate the door to close the main body based on the first sensor failing to identify the external object.

According to an embodiment, the one or more computer programs may further include computer-executable instructions that, when executed by the one or more processors individually or collectively, cause the refrigerator after opening the door relative to the main body at the second designated angle to control the door driver to rotate the door to close the main body based on the first sensor failing to identify the external object.

According to an embodiment, the one or more computer programs may further include computer-executable instructions that, when executed by the one or more processors individually or collectively, cause the refrigerator after the door is opened at the first designated angle, when the door is opened at the first designated angle by the external object, to control the door driver to rotate the door to close the main body after a first designated time in a state opened at the first designated angle.

According to an embodiment, the one or more computer programs may further include computer-executable instructions that, when executed by the one or more processors individually or collectively, cause the refrigerator after the door is opened in a range of the second designated angle to control the door driver to rotate the door to close the main body after a second designated time in a state opened at the second designated angle.

A refrigerator 1 according to an embodiment of the disclosure may comprise a main body 10, a door 30 rotatably connected to open or close the main body, a door driver 400 configured to automatically rotate the door from the main body, a lever device 100 disposed on the door to facilitate movement of the door, a guide 200 provided to guide movement of the lever device while being contacted by the lever device when the door rotates to open or close the main body, a first sensor 710 disposed on one side of the main body or the door to face in a forward direction to identify an external object, a second sensor 720 disposed on one side of the door to face in the forward direction to sense a distance based on identifying the external object by the first sensor, memory storing one or more computer programs, and one or more processors communicatively coupled to the door driver, the first sensor, the second sensor, and the memory. the one or more computer programs may include computer-executable instructions that, when executed by the one or more processors individually or collectively, cause the refrigerator in a closed state of the door to, obtain a distance value between the main body and the external object through the second sensor, and upon determining that the obtained distance value is a first threshold value or less, control the door driver to open the door at a first designated angle from the main body. The guide may include a curve point 213 which is a boundary point provided to apply a force in a direction in which the door opens or closes the main body among movement points of the lever device. The curve angle β may be defined as an angle of an imaginary line connecting the curve point and a rotation shaft X of the door from the main body, and the first designated angle α may have a value smaller than or equal to the curve angle.

According to an embodiment, the one or more computer programs may further include computer-executable instructions that, when executed by the one or more processors individually or collectively, cause the refrigerator in a closed state of the door to control the door driver to open the door relative to the main body at a second designated angle larger than the first designated angle upon determining that the obtained distance value exceeds the first threshold value.

According to an embodiment, the sensor may further include a third sensor disposed adjacent to the door driver to sense an angle of the door relative to the main body. The one or more computer programs may further include computer-executable instructions that, when executed by the one or more processors individually or collectively, cause the refrigerator in an open state of the door to, obtain an angle value between the main body and the door through the third sensor, and upon determining that the obtained angle value exceeds the first designated angle and the distance value obtained by the second sensor exceeds a second threshold value, control the door driver to close the door relative to the main body.

According to an embodiment, the sensor may further include a third sensor disposed adjacent to the door driver to sense an angle of the door relative to the main body. The one or more computer programs may further include computer-executable instructions that, when executed by the one or more processors individually or collectively, cause the refrigerator in an open state of the door to, obtain an angle value between the main body and the door through the third sensor, and upon determining that the obtained angle value exceeds the first designated angle and after a designated time, control the door driver to close the door relative to the main body.

It will be appreciated that an embodiment of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement an embodiment of the disclosure. Accordingly, ac embodiment provide a program comprising code for implementing apparatus or a method as claimed in any one of the claims of this specification and a non-transitory machine-readable storage storing such a program.

While the disclosure has been shown and described with reference to an embodiment thereof, it will be understood by those skilled in the art that various changes in form and details may be made therein without departing from the spirit and scope of the disclosure as defined by the appended claims and their equivalents.

What is claimed is:

1. A refrigerator, comprising:
a main body;
a door rotatably connected to open or close the main body;
a door driver configured to automatically rotate the door relative to the main body;
a sensor disposed at one side of the main body or the door to face in a front direction;
memory storing one or more computer programs; and
one or more processors communicatively coupled to the door driver, the sensor, and the memory,
wherein the one or more computer programs include computer-executable instructions that, when executed by the one or more processors individually or collectively, cause the refrigerator in a closed state of the door to:
determine whether a sensing data value obtained by the sensor is a first threshold value or less,
control the door driver to open the door relative to the main body at a first designated angle based on determining that the sensing data value is the first threshold value or less, and
control the door driver to open the door relative to the main body at a second designated angle larger than the first designated angle based on determining that the sensing data value exceeds the first threshold value.

2. The refrigerator of claim 1, further comprising:
a lever device disposed on the door to facilitate movement of the door; and
a guide provided to guide movement of the lever device while being contacted by the lever device when the door rotates to open or close the main body,
wherein the guide includes a curve point which is a boundary point provided to apply a force in a direction in which the door opens or closes the main body among movement points of the lever device,
wherein the curve angle is defined as an angle of an imaginary line connecting the curve point and a rotation shaft of the door from the main body, and
wherein the first designated angle has a value smaller than or equal to the curve angle.

3. The refrigerator of claim 2, wherein the second designated angle has a value exceeding the curve angle.

4. The refrigerator of claim 1,
wherein the sensor includes:
a first sensor disposed on one side of the main body or the door to face in the front direction to identify an external object, and
a second sensor disposed on one side of the door to face in the front direction to sense a distance based on identifying the external object by the first sensor, and
wherein the sensing data value includes a distance value between the main body and the external object through the second sensor.

5. The refrigerator of claim 4, further comprising:
a third sensor disposed adjacent to the door driver to sense an angle of the door relative to the main body,
wherein the one or more computer programs further include computer-executable instructions that, when executed by the one or more processors individually or collectively, cause the refrigerator in an open state of the door to:
obtain an angle value between the main body and the door through the third sensor, and
upon determining that the obtained angle value exceeds the first designated angle and the distance value obtained by the second sensor exceeds a second threshold value, control the door driver to close the door relative to the main body.

6. The refrigerator of claim 1, further comprising:
a third sensor disposed adjacent to the door driver to sense an angle of the door relative to the main body,
wherein the one or more computer programs further include computer-executable instructions that, when executed by the one or more processors individually or collectively, cause the refrigerator in an open state of the door to:
obtain an angle value between the main body and the door through the third sensor, and
upon determining that the obtained angle value exceeds the first designated angle and after a designated time, control the door driver to close the door relative to the main body.

7. The refrigerator of claim 1,
wherein the first designated angle is one of 45 degrees or less, and
wherein the second designated angle is one of larger than 45 degrees, and smaller than or equal to 180 degrees.

8. The refrigerator of claim 1, wherein the door driver includes:
a motor;
a pusher configured to push to open the door from the main body;
a link disposed to connect the main body and the door and including a first link portion and a second link portion rotatably connected to one end of the first link portion; and
a plurality of gears for transferring a driving force of the motor to the pusher and/or the link.

9. The refrigerator of claim 8, wherein, to open the door at the first designated angle, the one or more computer programs further include computer-executable instructions that, when executed by the one or more processors individually or collectively, cause the refrigerator to control the door driver to:
withdraw the pusher from the main body, and
control the pusher to push the door and the door to open while rotating about a door rotation shaft according to the withdrawing of the pusher from the main body.

10. The refrigerator of claim 8, wherein, to open the door at the second designated angle, the one or more computer programs further include computer-executable instructions that, when executed by the one or more processors individually or collectively, cause the refrigerator to control the door driver to:
withdraw and rotate a portion of the pusher and/or the link from the main body through the door driver, and
control the link to apply a force to the door and the door to open while rotating about a door rotation shaft of the door.

11. The refrigerator of claim 4, wherein, after the door is opened at the first designated angle, when the door is opened at the first designated angle by the external object, the one or more computer programs further include computer-executable instructions that, when executed by the one or more processors individually or collectively, cause the refrigerator to control the door driver to control the door driver to rotate the door to close the main body based on the first sensor failing to identify the external object.

12. The refrigerator of claim 4, wherein the one or more computer programs further include computer-executable instructions that, when executed by the one or more processors individually or collectively, cause the refrigerator after opening the door relative to the main body at the second designated angle to control the door driver to rotate the door to close the main body based on the first sensor failing to identify the external object.

13. The refrigerator of claim 8, wherein, after the door is opened at the first designated angle, a portion of the pusher, withdrawn from the main body, returns to an inside of the main body, and the door closes the main body by its own weight.

14. The refrigerator of claim 4, wherein the one or more computer programs further include computer-executable instructions that, when executed by the one or more processors individually or collectively, cause the refrigerator after the door is opened at the first designated angle, when the door is opened at the first designated angle by the external object, to control the door driver to rotate the door to close the main body after a first designated time in a state opened at the first designated angle.

15. The refrigerator of claim 4, wherein the one or more computer programs further include computer-executable instructions that, when executed by the one or more processors individually or collectively, cause the refrigerator after the door is opened in a range of the second designated angle to control the door driver to rotate the door to close the main body after a second designated time in a state opened at the second designated angle.

16. The refrigerator of claim 8,
wherein the pusher is configured to be movable between a first pusher position which is a position of the pusher when the main body is closed and a second pusher position moved from the first pusher position in a direction pressing the door, and
wherein when the door is at the first designated angle from the main body, the pusher is positioned between the first pusher position and the second pusher position and, when the door is at the second designated angle from the main body, the pusher is positioned at the second pusher position.

17. The refrigerator of claim 8,
wherein the pusher is configured to be movable between a first pusher position which is a position of the pusher when the main body is closed and a second pusher position moved from the first pusher position in a direction pressing the door, and
wherein when the door is at the first designated angle from the main body, the pusher is positioned at the second pusher position and, when the door is at the second designated angle from the main body, the pusher is positioned at the first pusher position.

18. The refrigerator of claim 8,
wherein the link includes a first link portion rotatably connected to the main body and a second link portion rotatably connected to the door,
wherein the link is configured to be movable between a first link position which is a position of one end of the second link portion when the main body is closed and a second link position moved from the first link position in a direction pressing the door, and
wherein when the door is at the first designated angle from the main body, the link is positioned between the first link position and the second link position and, when the door is at the second designated angle from the main body, the link is positioned at the second link position.

19. A refrigerator, comprising:
a main body;
a door rotatably connected to open or close the main body;
a door driver configured to automatically rotate the door relative to the main body;
a lever device disposed on the door to facilitate movement of the door;
a guide provided to guide movement of the lever device while being contacted by the lever device when the door rotates to open or close the main body;
a first sensor disposed on one side of the main body or the door to face in a forward direction to identify an external object;
a second sensor disposed on one side of the door to face in the forward direction to sense a distance based on identifying the external object by the first sensor;
memory storing one or more computer programs; and
one or more processors communicatively coupled to the door driver, the first sensor, the second sensor, and the memory,
wherein the one or more computer programs include computer-executable instructions that, when executed by the one or more processors individually or collectively, cause the refrigerator in a closed state of the door to:
obtain a distance value between the main body and the external object through the second sensor, and
upon determining that the obtained distance value is a first threshold value or less, control the door driver to open the door at a first designated angle from the main body,
wherein the guide includes a curve point which is a boundary point provided to apply a force in a direction in which the door opens or closes the main body among movement points of the lever device,
wherein a curve angle is defined as an angle of an imaginary line connecting the curve point and a rotation shaft of the door from the main body, and
wherein the first designated angle has a value smaller than or equal to the curve angle.

20. The refrigerator of claim 19, wherein the one or more computer programs further include computer-executable instructions that, when executed by the one or more processors individually or collectively, cause the refrigerator in a closed state of the door to control the door driver to open the door relative to the main body at a second designated angle larger than the first designated angle upon determining that the obtained distance value exceeds the first threshold value.
